(19) United States
(12) Patent Application Publication
(10) Pub. No.: US 2023/0271326 A1
(43) Pub. Date: Aug. 31, 2023

(54) CONTROL SYSTEM FOR EXOSUITS

(71) Applicant: X Development LLC, Mountain View, CA (US)

(72) Inventor: Radu Gogoana, Burlingame, CA (US)

(21) Appl. No.: 17/683,285

(22) Filed: Feb. 28, 2022

(51) Int. Cl. B25J 9/16; B25J 9/00

(52) U.S. Cl. CPC B25J 9/1694; B25J 9/0006; A61H 3/00

(57) ABSTRACT

Methods, systems, and apparatus, for control systems for exosuits. In some implementations, a motor command to drive a motor of the exosuit is received. A reference value that indicates a desired level of force is determined from the motor command. A measurement is obtained from a load cell of the exosuit. A motor signal to provide to the motor that is expected to adjust the force applied to the load cell towards the desired level of force is determined. The motor signal is provided to the motor to adjust a force applied by the motor.

### TECHNICAL FIELD

The present specification relates to control systems for exosuits.

### BACKGROUND

In general, powered exosuits can provide a wearer increased strength and endurance while allowing for limb movement of the wearer. Exosuits have been used in a variety of applications, including industrial settings, rehabilitation after injuries, and as assistive devices to improve mobility. However, many exosuits are heavy and bulky, and are not appropriate for general purpose use. For example, powerful exoskeletons can assist a worker during assembly line production and may alleviate fatigue for specific repetitive tasks. Nevertheless, exoskeletons like these are too large and inflexible to assist a user in everyday mobility and common household tasks.

### SUMMARY

In some implementations, an exosuit has a drive system that includes an actuator and a multi-stage force transmission mechanism. To minimize weight and provide a low profile, the exosuit can include a small, lightweight motor. The motor can rotate at a high speed, and the transmission mechanism can provide a speed reduction to allow for high torque to be applied at a joint. The first stage of the transmission can be a belt drive, which operates much more quietly than a gearbox. The second stage can be a winch or capstan drive with anchored cables. The winch is also very quiet, and can transmit very large torques, limited mainly by the tensile strength of the cable used. Together, the two stages of the transmission can greatly reduce rotational speed and increase torque with low weight, low noise, and a very low profile.

The multi-stage transmission that provides a high reduction in rotation between the motor and the joint to be actuated enables a small, high-RPM motor to be used, which limits weight. The design also enables the motor and the transmission to be placed proximally with respect to the joint of the wearer (e.g., knee, elbow, ankle, hip, shoulder, etc.). This allows the heaviest components (e.g., motor, battery, transmission, etc.) to be placed nearer to the center of gravity of the wearer, which increases mechanical efficiency of the exosuit. Overall, the drive system is capable of delivering high torque in a small, lightweight form factor while operating quietly.

Some prior exosuit designs place an actuator, such as a motor, at the knee of the wearer. The actuators used can be heavy, often 4-6 pounds each. Placement of such a large weight at the knee can hinder a natural gait and can reduce the efficiency of movement. The high weight and placement of the actuator at the knee often lead to low efficiency of movement, with the large mass of the actuator swinging and negatively affecting the movement as the wearer walks. The actuators are also often very bulky, potentially extending several inches from the lateral sides of the wearer's legs where they may hit doorways, furniture, and other objects during movement.

Compared to the prior designs, the exosuit designs discussed herein can use a much lighter type of actuator and place the actuator more proximally. The transmission that delivers force to the joint can also be located proximal to the joint can and can use very lightweight elements, such as belts and cables. These changes can significantly improve biomechanical efficiency for a wearer of the exosuit and also improve the comfort and overall experience for the wearer.

As an example, the exosuit can include a motor to deliver force to assist a user in flexing and extending the user's knee joint. The motor can be placed in the exosuit so that the motor is located along the lateral side of the user's thigh, for example, approximately halfway between the knee and the hip or even closer to the hip. The exosuit can use a multi-stage transmission to transmit force to the knee, quietly converting a high-RPM output of the motor to a high torque at the knee. The exosuit can have a portion that lays along the user's thigh, and has a low profile extending laterally outward, for example, 2-3 inches or less at its maximum width in the lateral direction (e.g., at the motor) and narrowing significantly in the lateral direction moving distally along the actuator drive. The motor can be a brushless electric motor, such as a an out-runner motor that produces high torques and that has a stator and rotor that are thin in the lateral dimension. For example, the size of the motor along a medial-lateral axis direction can be less (e.g., half or less) than the size of the motor in either of the anterior-posterior and inferior-superior axes.

The exosuit can be configured to provide support without impeding natural movement of the user. Due to the high speed ratio between the rotation of the motor and the rotation of the knee joint, the exosuit has the potential to provide a high level of resistance (e.g., high reflected inertia or load) to the wearer when the wearer attempts to actuate the joint. To avoid presenting this resistance from the wearer, the exosuit can use one or more sensors to detect forces applied by the wearer and can actively move the joint in response. The exosuit can include a sensing mechanism that provides high responsiveness and high accuracy, so the exosuit can initiate movement with a relatively low force threshold. This allows the exosuit to actuate the joint and respond quickly to small movements by the wearer, so as not to impede intended movements by the wearer.

For example, the exosuit can use a sensing mechanism that places a sensor near the joint. The sensor can be placed after or integrated with the last reduction stage of the transmission. As a result, the sensor senses force very close to the joint, allowing high accuracy and sensitivity through placement after most or all of the speed reduction by the transmission has occurred and after most of the frictional losses in the drive system. The sensor can be a load cell placed to sense forces for both flexion and extension. For example, the load cell can be part of an assembly that is placed between two cord segments of the winch drive, which apply opposing forces to the load cell. One end of the load cell assembly can be anchored on the exosuit, with another end being unanchored and free to be influenced by the two cord segments. The cord segments can both apply their forces to the load cell through pulleys coupled to the load cell, allowing the load cell to sense a combination of the forces from the cord segments.

The exosuit can have a control system that responds to the signal from the load cell to control the motor. The control system can use a feedback loop that targets a net force of zero on the load cell, representing a balance between the opposing forces applied by the two cord segments. The control system can respond to changes in the load cell output by adjusting motor output to change the force on the load cell toward the an equilibrium, zero-net-force condition. With this type of control system, the exosuit can be very responsive to user force and movement. When the control system senses an increase in net force on the load cell (e.g., indicating that the forces applied by the two cord segments are out of balance), the control system can drive the motor in a manner that compensates for the increased force.

The control system can respond to the load cell signal to correct imbalances in force that occur for any of various reasons. For example, when a user begins to stand up from a sitting position, the force applied to the load cell by the upper cord segment will decrease slightly and the force applied to the load cell by the lower cord segment will decrease slightly, resulting in a net force on the load cell. The feedback loop in the control system acts on this change of force to drive the motor and wind the winch in the transmission to concurrently shorten the upper cord segment and lengthen the lower cord segment, which causes an extension of exosuit at the user's knee. As the user continues to apply force to stand up, even though it may be much less than the amount needed to support the user's weight, the control system continues to drive the motor to extend the knee joint, responsive to the user's applied force. The feedback loop can thus respond to a user's motion to adjust the direction (e.g., extension vs. flexion), speed, and magnitude of motor drive to facilitate the movement the user is attempting.

As another example, a wearer of the exosuit may be sitting down and may attempt to move the foot backward, perhaps to position the foot before standing up or even just allowing knee to bend freely to swing the foot back and forth. In this situation, the control system can hide the high reflected inertia that the user faces due to the high reduction ratio from the motor to the knee joint. In other words, when the wearer applies force to initiate flexion, the apparent resistance sensed by the wearer is low because the feedback loop actively drives the motor to bend the joint. For example, a user's force toward flexion increases tension in the upper cord segment and increases the force the upper cord segment applies on the load cell, while the same force by the user decreases tension in the lower cord segment and decreases the force the lower cord segment applies on the load cell. The feedback loop responds by gradually driving the motor to compensate for this change in net force on the load cell, by driving the motor to flex the knee. The characteristics of the motor drive signals, e.g., the direction, speed, duration, and extent of motor activation, can be set based on the parameters of the feedback loop and the characteristics of the load cell signal over time (e.g., whether net force increases or decreases from the equilibrium point, the magnitude of change from the equilibrium point, the rate or pattern with which the load cell signal changes, how long the deviation from equilibrium persists, etc.).

The control system can use various constraints or modes in addition to the feedback loop that attempts to maintain a net zero force on the load cell. The control signals to the motor can be adjusted based on the context or detected type of movement needed. For example, when the control system detects that a user is standing from a sitting position, the control system can respond quickly and in proportion to the force the user applies to flex the knee joint. While the response may be limited for safety or tuned for individual capabilities or preferences, the feedback loop can nevertheless respond to strong forces to help the user stand up quickly and respond to weaker forces to stand up more gradually. On the other hand, when the control system detects that the user is sitting down from a standing position, the control system can

In one general aspect, an exosuit includes a proximal portion, a distal portion, and a joint coupling the proximal and distal portion, where the joint enables rotation of the distal portion about an axis with respect to the proximal portion. The exosuit includes a motor coupled to the proximal portion and a transmission configured to apply force from the motor to actuate the joint. The transmission includes multiple stages of reduction, including: a first stage comprising a belt that couples the motor to a drive pulley such that rotation of the motor rotates the drive pulley; and a second stage comprising (i) a winch having a spool configured to rotate with the drive pulley, and (ii) a cord that couples the spool to the distal portion such that rotation of the spool applies a force to actuate the joint.

In one general aspect, an exosuit includes: a proximal portion, a distal portion, and a joint coupling the proximal and distal portion, wherein the joint enables rotation of the distal portion about an axis with respect to the proximal portion; a motor coupled to the proximal portion; and a transmission configured to apply force from the motor to actuate the joint, the transmission including multiple stages of reduction, including: a first stage comprising a belt that couples the motor to a drive pulley such that rotation of the motor rotates the drive pulley; and a second stage comprising (i) a winch having a spool configured to rotate with the drive pulley, and (ii) a cord that couples the spool to the distal portion such that rotation of the spool applies a force to actuate the joint.

In some implementations, the exosuit is configured to provide powered support for a leg of a wearer of the exosuit, the proximal portion being configured to be placed along an upper portion of the leg and the distal portion being configured to be placed along a lower portion of the leg, with the joint being configured to be located at a knee of the leg.

In some implementations, the first stage and the second stage of the transmission are coupled to the proximal portion.

In some implementations, the cord has a first portion and second portion that respectively extend from the spool to different regions of the distal portion, the cord being arranged such that (i) rotating the spool in a first direction winds cord of the first portion onto the spool and winds cord of the second portion off of the spool, and (ii) rotating the spool in a second direction winds cord of the first portion off the spool and winds cord of the second portion onto the spool.

In some implementations, ends of the first portion of the cord and the second portion of the cord are anchored to the distal portion.

In some implementations, a central portion of the cord is anchored to the spool.

In some implementations, the cord is formed of aramid or para-aramid fibers.

In some implementations, the exosuit includes a first encoder coupled to the motor and a second encoder coupled to the joint.

In some implementations, the exosuit includes a load cell assembly coupled to one or more pulleys that are arranged to engage the cord.

In some implementations, the one or more pulleys comprise: a first guide pulley to engage a first segment of the cord; and a second guide pulley to engage a second segment of the cord. The load cell assembly comprises a load cell coupled to the first guide pulley and the second guide pulley such that tension in the first and second segments of the cord applies force in opposing directions to the load cell.

In some implementations, the motor is a brushless outrunner motor.

In some implementations, the motor is coupled to a plate of the proximal portion, and wherein the motor has a dimension in a plane parallel to the plate that is larger than a dimension of the motor in a direction perpendicular to the plate.

In another general aspect, a method includes: operating an exosuit comprising a proximal portion, a distal portion, and a joint coupling the proximal and distal portion, wherein the joint enables rotation of the distal portion about an axis with respect to the proximal portion; and applying force from a motor mounted to the proximal portion to the distal portion using a transmission that includes multiple stages of reduction, comprising: using a first stage of the transmission to transmit force from the motor to a drive pulley through a belt such that rotation of the motor rotates the drive pulley; and using a second stage of the transmission to transmit force from a spool coupled to the drive pulley to the distal portion through a cord, wherein the cord couples the spool to the distal portion such that rotation of the spool applies a force to actuate the joint.

In some implementations, operating the exosuit comprises providing powered support for a leg of a wearer of the exosuit, the proximal portion being placed along an upper portion of the leg and the distal portion being placed along a lower portion of the leg, with the joint being located at a knee of the leg.

In some implementations, using the second stage of the transmission comprises using the spool as a winch for a first portion of the cord and a second portion of the cord, the cord being arranged such that (i) rotating the spool in a first direction winds cord of the first portion onto the spool and winds cord of the second portion off of the spool, and (ii) rotating the spool in a second direction winds cord of the first portion off the spool and winds cord of the second portion onto the spool.

In some implementations, ends of the first portion of the cord and the second portion of the cord are anchored to the distal portion.

In some implementations, a central portion of the cord is anchored to the spool.

In some implementations, the cord is formed of aramid or para-aramid fibers.

In some implementations, the transmission provides a speed ratio of between 20:1 and 200:1.

In some implementations, operating the exosuit comprises providing powered support for movement of a knee or elbow of a wearer of the exosuit.

In some implementations, the exosuit provides powered support for movement of a hip, shoulder, ankle, or other joint of the wearer.

In another general aspect, an exosuit includes: a proximal portion, a distal portion, and a joint coupling the proximal and distal portion, wherein the joint enables rotation of the distal portion about an axis with respect to the proximal portion; a motor coupled to the proximal portion; a transmission configured to apply force from the motor to actuate the joint, the transmission comprising a spool arranged to be driven by the motor, a first cord segment extending from the spool to the distal portion, and a second cord segment extending from the spool to the distal portion; and a load cell assembly comprising a load cell and pulleys located at opposite sides of the load cell, the pulleys comprising (i) a first pulley to engage the first cord segment such that tension in the first cord segment applies a force on the load cell in a first direction and (ii) a second pulley to engage the second cord segment such that tension in the second cord segment applies a force in a second direction opposing the first direction.

In some implementations, the load cell is configured to provide an output indicative of a combination of forces transmitted on the pulleys by the first cord segment and the second cord segment.

In some implementations, the load cell assembly has a first end and a second end, wherein the first end of the load cell assembly is anchored to the proximal portion of the exosuit, and wherein the second end of the load cell assembly is free, the pulleys being located at the second end of the load cell assembly and are coupled to move with the second end of the load cell assembly relative to the proximal portion.

In some implementations, the load cell is a piezoelectric load cell.

In some implementations, the load cell comprises a spring and a potentiometer.

In some implementations, the transmission provides a speed ratio of between 10:1 and 400:1.

In some implementations, the transmission provides a speed ratio of between 20:1 and 200:1.

In some implementations, the exosuit includes a control unit configured to control the operation of the motor based on signals from the load cell.

In some implementations, the control unit is configured to activate the motor based on the signals from the load cell to reduce reflected inertia presented to a wearer of the exosuit.

In some implementations, the control unit is configured to: detect force applied by a wearer of the exosuit using the signals from the load cell; and drive the motor to reduce resistance of the exosuit to the force applied by the wearer.

In some implementations, the control unit is configured to use a feedback loop to drive the motor to balance forces on the load cell.

In some implementations, in at least one operating mode, the feedback loop attempts to maintain zero net force on the load cell.

In another general aspect, a method includes: providing, by an exosuit, powered support to a wearer of the exosuit, the exosuit comprising a proximal portion, a distal portion, and a joint coupling the proximal and distal portion, wherein the joint enables rotation of the distal portion about an axis with respect to the proximal portion; sensing force using a load cell assembly in the exosuit, the load cell assembly comprising a load cell and pulleys located at opposite sides of the load cell, the pulleys comprising (i) a first pulley to engage a first cord segment such that tension in the first cord segment applies a force on the load cell in a first direction and (ii) a second pulley to engage a second cord segment such that tension in the second cord segment applies a force in a second direction opposing the first direction; controlling a motor of the exosuit based on sensed force measured by the load cell; and transmitting force from the motor to the distal portion of the exosuit using a transmission comprising a spool arranged to be driven by the motor, the spool being configured to wrap and unwrap the first cord segment and the second cord segment on the spool to vary the position of the distal portion of the exosuit with respect to the proximal portion of the exosuit.

In some implementations, sensing the force comprises providing an output indicative of a combination of forces transmitted on the pulleys by the first cord segment and the second cord segment.

In some implementations, the load cell assembly has a first end and a second end, wherein the first end of the load cell assembly is anchored to the proximal portion of the exosuit, and wherein the second end of the load cell assembly is free, the pulleys being located at the second end of the load cell assembly and are coupled to move with the second end of the load cell assembly relative to the proximal portion.

In some implementations, the transmission provides a speed ratio of between 10:1 and 400:1.

In some implementations, controlling the motor comprises activating the motor based on the force sensed by the load cell to reduce reflected inertia presented to a wearer of the exosuit.

In some implementations, controlling the motor comprises: detecting force applied by a wearer of the exosuit using the signals from the load cell; and driving the motor to reduce resistance of the exosuit to the force applied by the wearer.

In some implementations, controlling the motor comprises operating a feedback loop to drive the motor to balance forces applied by the first cord segment and the second cord segment on the load cell assembly.

In some implementations, providing powered support to the wearer comprises providing force to actuate or stabilize a knee, shoulder, ankle, hip, or shoulder of the wearer.

In another general aspect, a method for controlling an exosuit includes: receiving, by a controller of the exosuit, a motor command to drive a motor of the exosuit, wherein the motor is coupled to rotate a drive pulley, and wherein the drive pulley is coupled to a moveable portion of the exosuit with a cord and is configured such that rotation of the drive pulley winds or unwinds the cord around a spool coupled to the drive pulley; determining, based on the motor command, a reference value that indicates a desired level of force; obtaining a measurement from a load cell of the exosuit, wherein the load cell is arranged such that tension in the cord applies force to the load cell and the measurement from the load cell is based on the force applied; based on the reference value and the measurement, determining a motor signal to provide to the motor that is expected to adjust the force applied to the load cell towards the desired level of force; and providing the motor signal to the motor to adjust a force applied by the motor to the drive pulley.

In some implementations, the method includes: obtaining a second measurement from the load cell of the exosuit that indicates that the force applied to the load cell has changed; determining a second motor signal that is expected to further adjust the force applied to the load cell; and providing the second motor signal to the motor to adjust the force applied by the motor to the drive pulley.

In some implementations, the cord has a first cord segment and a second cord segment, and rotation of the drive pulley in a first direction winds the first cord segment and unwinds the second cord segment, and rotation of the drive pulley in a second direction winds the second cord segment and unwinds the first cord segment.

In some implementations, the load cell is arranged between the first cord segment and the second cord segment such that tension in the first cord segment and tension in the second cord segment apply opposing forces to the load cell, and the force applied to the load cell is a combination of the opposing forces applied to the load cell by the first cord segment and the second cord segment.

In some implementations, the combination of the opposing forces applied to the load cell is a net force of the opposing forced applied to the load cell.

In some implementations, the load cell is coupled to guide pulleys. A first guide pulley of the guide pulleys engages the first cord segment and a second guide pulley of the guide pulleys engages the second cord segment. The opposing forces to the load cell are applied to the load cell through the guide pulleys.

In some implementations, the load cell has a first end that is anchored to a housing of the exosuit and a second end that is movable within the housing of the exosuit, and the opposing forces to the load cell are applied to the second end of the load cell.

In some implementations, the reference value indicates a desired measurement value from the load cell.

In some implementations, the reference value represents a desired force to be applied to the load cell.

In some implementations, the method includes accessing a lookup table that corresponds to the reference value. Using the reference value and the measurement to determine the motor signal comprises identifying, from the lookup table, a motor signal for the measurement.

In some implementations, the lookup table relates possible measurements from the load cell or measurement ranges to different motor signals to provide to the motor.

In some implementations, method comprising identifying a control algorithm that corresponds to the reference value. Using the reference value and the measurement to determine the motor signal comprises using the control algorithm to calculate the motor signal, wherein the measurement is provided as an input to the control algorithm.

In some implementations, the load cell includes multiple sensing devices.

In some implementations, the multiple sensing devices are arranged in a Wheatstone bridge circuit, and obtaining the measurement from the load cell of the exosuit comprises obtaining an output of the Wheatstone bridge circuit.

In some implementations, the load cell includes one or more strain gauges.

In another general aspect, a method comprises: obtaining a measurement from a load cell of the exosuit, wherein the exosuit has a motor configured to apply force to a joint of a wearer of the exosuit, wherein the motor is coupled to a moveable portion of the exosuit through a drive assembly that includes a drive pulley configured to wind or unwind cord segments around a spool coupled to the drive pulley, and wherein the load cell is arranged such that a first cord segment and a second cord segment apply opposing forces to the load cell and the measurement is indicative of a combination of the opposing forces; determining a reference value that indicates a desired level of force applied to the load cell; based on the reference value and the measurement from the load cell, determining a motor signal to realize the desired level of force; and providing the motor signal to the motor to adjust a force applied by the motor to the drive pulley.

In some implementations, the drive assembly is a multi-stage drive assembly comprising multiple stages of speed ratio reduction. The first stage includes a connection between the motor and the drive pulley, and a diameter of a spindle of the motor is less than a diameter of the drive pulley. The second stage includes a connection between the drive pulley and the spool, wherein the diameter of the drive pulley is greater than a diameter of the spool. The load cell is located between the second stage and the movable portion of the exosuit. Determining a motor signal based on the reference value and the measurement from the load cell comprises: using the gear ratios, the measurement, and the reference value to calculate a force to be applied by the motor to achieve the desired level of force, and determining a motor signal that is expected to cause the motor to apply the calculated force to the drive pulley; or identifying, from a lookup table that corresponds to the reference value and that accounts for the gear ratios, a force to be applied by the motor to achieve the desired level of force, and determining a motor signal that is expected to cause the motor to apply the identified force to the drive pulley.

In some implementations, the method includes: obtaining a second measurement from the load cell indicating that the combination of the opposing forces is substantially equal to the desired level of force; based on the combination of the opposing forces being substantially equal to the desired level of force, determining that no change to the motor signal is necessary to achieve the desired level of force; and providing the motor signal to the motor to maintain the force applied by the motor to the drive pulley.

In some implementations, the method includes: obtaining a third measurement from the load cell after the wearer of the exosuit introduces an external force to the exosuit at the joint of the wearer, wherein the external force changes tensions in the cord segments and the forces applied to the load cell such that the combination of the opposing forces is no longer substantially equal to the desired level of force; based on the reference value and the second measurement, determining a second motor signal to account for the external force and to realize the desired level of force; and providing the second motor signal to the motor to adjust the force applied by the motor to the drive pulley.

In some implementations, the reference value indicates a desired net-zero force applied to the load cell, and determining the motor signal comprises determining a motor signal expected to reduce the combination of the opposing forces toward the desired net-zero force; or the reference value indicates a desired non-zero force applied to the load cell, and determining the motor signal comprises determining a motor signal expected to adjust the combination of the opposing forces toward the desired non-zero force.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1A is a side view of an example of an exosuit worn by a wearer.

FIG. 1B is a front view of the exosuit of FIG. 1A.

FIG. 2 is a top perspective view of the exosuit of FIG. 1A.

FIG. 3A is a top perspective view showing the drive system of the exosuit of FIG. 1A.

FIG. 3B is a top view showing the drive system of the exosuit of FIG. 1A.

FIG. 4 is a perspective view of a load cell assembly of the exosuit of FIG. 1A.

FIG. 5 is a bottom perspective view of the exosuit of FIG. 1A.

FIG. 6 is an exploded view of the exosuit of FIG. 1A.

FIGS. 7-9 are partial exploded views of the exosuit of FIG. 1A.

FIG. 10 is a diagram indicating control elements that can be used to control the exosuit of FIG. 1A.

FIGS. 11A-11B are diagrams showing example techniques for operating the exosuit using a feedback loop.

FIGS. 12A-12B are diagrams showing example techniques for operating the exosuit using a feedback loop.

FIG. 13 is a flowchart of an example process for operating the exosuit using a feedback loop.

Like reference numbers and designations in the various drawings indicate like elements.

### DETAILED DESCRIPTION

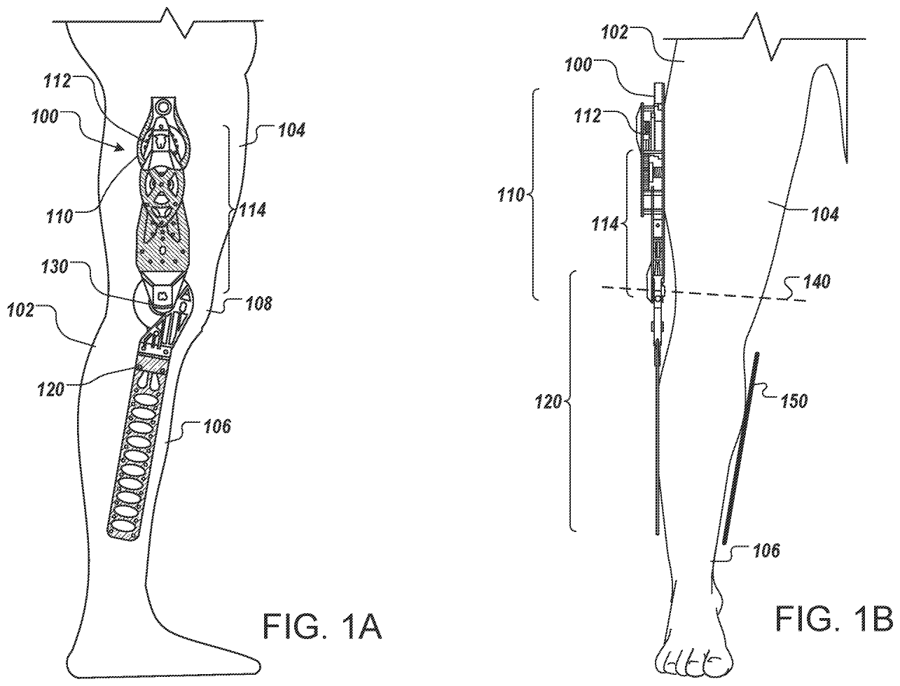

FIGS. 1A-1B show an example of a powered exosuit 100 that is worn by a human wearer 102. The exosuit 100 can assist the wearer 102 to provide increased, strength and endurance. For example, the exosuit 100 can be a powered exoskeleton to enhance movement for one or more limbs or joints of the wearer. The exosuit 100 is configured to sense movement or force applied by the user, to detect the type of support needed, and to provide active, powered support to facilitate the body movement intended by the user. In the example, the exosuit 100 is configured to enhance movement of a leg of the wearer 102, and so provides force to induce or support flexion and extension of the wearer's knee 108.

In the example, the exosuit 100 is shown with components to assist the right leg of the wearer 102, but another device with the same functionality can be provided top also support the left leg of the wearer 102. The two devices, one for each leg, can be physically separate, each with their own motors, power sources, control units, etc. The devices can include wireless transceivers to communicate with each other and to coordinate their movements. For example, two different leg support devices, each configured to be placed on lateral sides of different legs, can communicate over a Bluetooth connection to synchronize movement characteristics and timing to provide a natural gait, effective sitting and standing, and assistance for other movements.

The exosuit 100 can in a form factor that is suitable for daily, regular use. In some implementations, the exosuit 100 can be integrated into, inserted into, or worn under clothes. For example, the exosuit 100 can be designed to have a low profile to extend outward as little as possible from the body of the wearer 102, such as to extend laterally from the wearer's leg by three inches, two inches, or less at the maximum lateral size. The slim profile of the exosuit 100 can enable it to be sewn, strapped, or otherwise attached to a garment of the wearer 102. For example, a pair of pants or other type of garment can include a pocket or channel that the exosuit 100 slides into. The pants, and potentially straps, cuffs, or other connectors, can hold the exosuit 100 in place with respect to the wearer's leg and position it appropriately to bend at the wearer's knee 108. To facilitate stable placement of the exosuit 100 on the leg, the exosuit 100 can include a plate 150 configured to be placed on the lower leg 106. This plate 150 can be placed on the medial side of the leg, opposite a corresponding plate portion of the distal portion 120. The plate 150 can also be sewn, strapped, or otherwise attached to a garment of the wearer 102, to provide a connection to the wearer 102 at both the medial and lateral sides of the leg.

The exosuit 100 has a proximal portion 110, a distal portion 120, and a joint 130 that allows rotation of the distal portion 120 relative to the proximal portion 110 about an axis 140 of rotation. The proximal portion 110 is configured to be placed along the upper leg 104 of the wearer 102, where it is located on the lateral side of the thigh. From the upper leg 103, the proximal portion 110 extends inferiorly to the knee 108, where the joint 130 connects the proximal portion 110 to the distal portion 120. The joint 130 is placed so that the axis 140 of rotation aligns with the axis of rotation of the wearer's knee 108. The distal portion is configured to extend along the lower leg 106.

The exosuit 100 has a drive system that includes a motor 112 and a transmission 114 to deliver force from the motor 112 to actuate the joint 130 and thus assist the wearer 102 in performing flexion or extension of the knee 108. The exosuit 100 is configured to place the greatest mass of the drive system (and of the exosuit 100 as a whole) as proximally as possible. Placing the heaviest components as high on the leg as possible, nearest the center of gravity of the wearer 102, increases the comfort and efficiency of the exosuit 100. The farther toward the end of the leg that mass of the exosuit 100 is placed, the greater the amount of work is needed to move it back and forth during walking and other movements. To reduce the impact of the weight of the exosuit 100 on the wearer, the heaviest components such as the battery, motor 112, and transmission 114 are mounted on the proximal portion 110. For example, the motor 112 can be placed at the proximal end of the proximal portion 110, located to be placed at or above a midpoint (or even higher) of the wearer's upper leg. Compared to exoskeletons that place a motor at the user's knee, placing the motor 112 more superiorly allows for a much smaller reduction in biomechanical efficiency and a much lower impact on the user's gait.

In the exosuit 100, the greatest weight occurs at the proximal end of the proximal portion 110, and the weight decreases moving distally along the exosuit 100. This can include differences in weight for sections of the proximal portion 110 along the superior-inferior axis of the wearer. The distal portion 110 itself can be much lighter than the proximal portion, e.g., such as less than ⅕ or less than 1/10 of the weight of the proximal portion 110 that carries the drive system. For example, the majority of the length of the distal portion 120 can be thin, elongated metal plate, which can include a series of cutouts where material is removed, reducing the weight of the plate.

In the exosuit 100, in addition to weight of the exosuit 100 decreasing in a direction from proximal to distal (e.g., in an inferior direction along the superior-inferior axis), the width that the exosuit 100 extends laterally from the wearer's leg can also decrease in the direction from proximal to distal. As shown in FIG. 1B, the width of the exosuit 100 along the medial-lateral direction decreases at various steps moving inferiorly along the exosuit 100. Though the change is not strictly monotonic, the medial-lateral width (e.g., the average or maximum width of various sections) decreases at several steps or stages. This includes moving from a maximum width at the motor 112, stepping down to a second smaller width along a first reduction stage of the transmission 114, and then stepping down to an even smaller width along a second reduction stage of the transmission 114. The maximum medial-lateral width at the joint 130 is less than that of the motor 112 and the first stage of the transmission 114. The medial-lateral width of the distal portion 120 is even smaller, with a maximum width that is less than that of the joint 130 and with the width decreasing further distally.

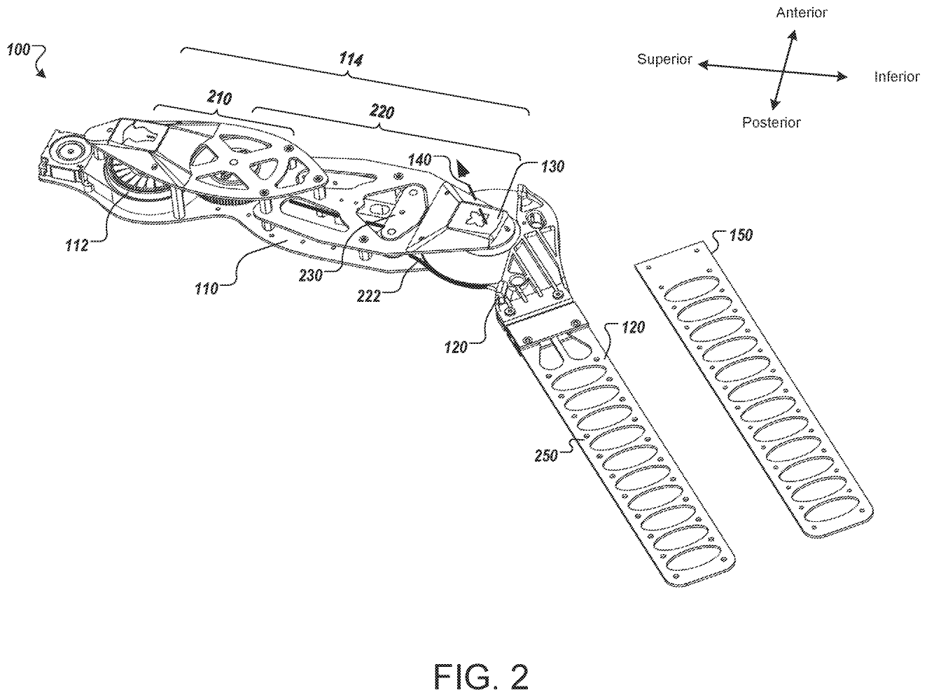

FIG. 2 is a top perspective view of the exosuit 100. In particular, FIG. 2 shows a perspective view of the lateral side of the exosuit 100, with the joint 130 at a rotational position of greater flexion than is shown in FIGS. 1A-1B.

The transmission 114 has two stages that each provide reduction in speed ratio between the rotation of the motor 112 and the rotation at the joint 130. These include a first stage 210 located closest to the motor 112, and a second stage 220 that extends to the joint 130. The first stage 210 is a belt drive, which uses a belt to couple a motor spindle with a drive pulley having a much larger diameter than the motor spindle. The second stage 220 is a winch drive or capstan drive that uses a cord 222 extending from a spool to the distal portion 120. The second stage 220 has a load cell assembly 230 that uses a load cell to detect and measure changing tension in the cord 222, which is used by a control system of the exosuit 100 to generate control signals that drive the motor 112.

The transmission 114 has very light weight and a high reduction ratio. Usually this combination of features leads to loud, distracting noises, especially when helical gears and intermeshed plastic or metal gears are used. However, the belt drive and winch drive of the transmission 114 allow the exosuit 100 to operate much more quietly, avoiding the loud whirring or buzzing that geared systems often produce.

The transmission 114 provides a speed ratio that is mostly consistent, but may vary slightly at different portions of the flexion/extension range due to different levels of wrapping of the cord 222 on the winch drive. The transmission 114 can be designed with an overall speed ratio in the range of from 20:1 to 200:1, or in the range from 10:1 to 400:1. As an example the first stage 210 can provide a speed ratio of approximately 8:1 and the second stage 220 can provide a speed ratio of approximately 7:1, resulting in an overall speed ratio of approximately 56:1. This high reduction between the speed of the motor 112 and the rotation of the joint 130 provides significant reflected inertia, and the wearer 102 would sense a high resistance when trying to bend the knee 108. Many prior exosuit designs use low speed ratios of 6:1 or less, in part to reduce the reflected inertia and decrease the backdriving force needed for a user to manipulate the exosuit. As will be discussed further below, the control system for the exosuit 100 can use the load cell assembly 230 to sense even slight torques that the wearer 102 applies, and the control system can actively respond to those torques to greatly reduce the apparent resistance from the exosuit 100 that the wearer 102 feels.

The structure of the transmission 114, with the two stages 210, 220 both mounted to the proximal portion 110, allows the heaviest components to be placed at the upper leg 104 where the weight will provide the least impact to the gait of the wearer 102. The transmission 114 is arranged with the heaviest stage, the first stage 210 with the motor 112, placed more proximally than the lighter second stage 220. Other than the cord 222 and a pulley structure on the distal portion 120 that engages the cord, all drive components are located above the knee 108. This allows the distal portion 120 to be very simple and light, primarily a pulley structure and a plate.

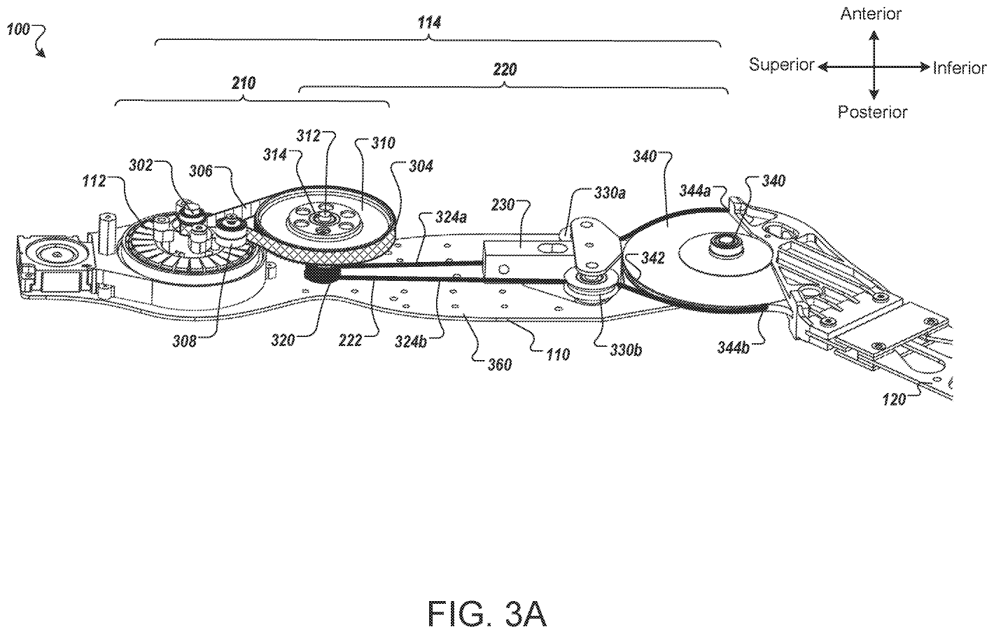

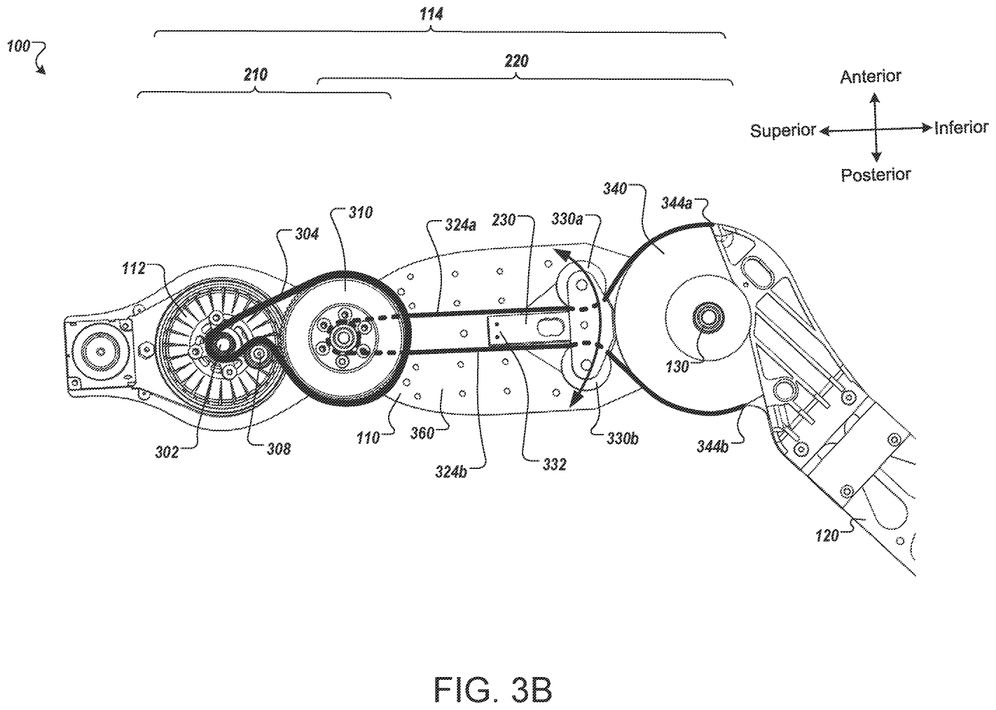

FIG. 3A is a perspective view showing components of the drive system of the exosuit 100. FIG. 3B is a top view showing components of the drive system.

The first stage 210 of the transmission 114 includes the motor 112, a belt 304, a drive pulley 310, and a tensioning pulley 308. The motor 112 can be an outrunner motor, with the rotor located inside the stator. While an inrunner motor can be used, outrunner motors are often preferred because they can produce more torque for the same build volume compared to inrunner motors. The motor can be designed with a low profile, with a diameter along the superior-inferior axis and along the anterior-posterior axis that is larger than the dimension of the motor 112 along the medial-lateral axis. The motor 112 can have a spindle 302 or shaft that extends in a lateral direction. Excluding the portion of the spindle 302 that extends from the motor 112, the superior-inferior dimension and anterior-posterior dimension of the motor 112 can be approximately two, three, or four times the medial-lateral dimension of the motor. As an example, the motor 112 can have a diameter of about four inches and have a height of approximately one inch along a medial-lateral direction. This results in a puck-like shape that helps minimize the distance that the exosuit 100 sticks out laterally from the wearer's leg.

The motor spindle 302 carries a gear that rotates with the spindle 302. The belt 304 has teeth 306 on the inner side of the belt 304, and the gear on the motor spindle 302 engages the teeth 306 so that rotation of the spindle 302 drives the belt 304.

The belt 304 extends in a path around the gear on the motor spindle 302 and around the drive pulley 310. The drive pulley 310 has a diameter that is significantly larger than the diameter of the gear on the motor spindle 302 to provide a significant reduction in rotational speed between the motor spindle 302 and the drive pulley 310, typically a speed ratio between 5:1 and 50:1. As an example, the drive pulley 310 can have a diameter of about four inches and the gear on the motor spindle 302 can have a diameter of about half an inch, for a speed ratio of 8:1. The tensioning pulley 308 engages the outer side of the belt 304 to maintain a desired level of tension in the belt 304.

The drive pulley 310 rotates around a fixed post 312 mounted on the proximal portion 110. The axis of rotation of the drive pulley 310 can be parallel to the axis of rotation of the motor spindle 302. The drive pulley 310 can be coupled to the post 312 with ball bearings 314 to limit friction in rotation of the drive pulley 310.

The second stage 220 of the transmission 114 uses a winch drive to transmit force from rotation of the drive pulley 310 to cause rotation of the distal portion 120 relative to the proximal portion 110 at the joint 130. The drive pulley 310 is attached to a spool 320 that rotates with the drive pulley 310 about the post 312. As the motor 112 drives the drive pulley 310 through the belt, the rotation of the drive pulley 310 causes the spool 320 to rotate, which winds and unwinds the cord 222 on the spool 320.

The cord 222 can be arranged with two cord segments 324a-324b that wrap in opposing directions. For example, clockwise rotation of the drive pulley 310 (and the attached spool 320) can unwind the upper cord segment 324a from the spool 320 while the same motion simultaneously winds the lower cord segment 324b onto the spool 320. Similarly, counterclockwise rotation of the drive pulley 310 can wind the upper cord segment 324a onto the spool 320 while the same motion simultaneously unwinds the lower cord segment 324b from the spool 320.

The cord segments 324a-324b can be anchored to the spool 320. For example, the cord segments 324a-324b can be anchored at the center of the spool 320 along the axis of rotation so that the two cord segments 324a-324b wrap around different portions of the spool 320. The anchoring of the cord segments 324a-324b to the spool 320 allows for extremely high torque transition. Also, with the anchored cord segments 324a-324b, there is no chance for the connection to slip as is possible with belts. The winch thus provides a very high torque in a very reliable and lightweight mechanism. The winch drive provided by the spool 320 and cord segments 324a-324b provides a limited number of revolutions of the spool 320 and so a limited degree of travel, but this can still provide the range of motion needed (e.g., a range of 110 degrees at the joint 130).

The cord 222, e.g., cord segments 324a-324b, can be a cord formed of aramid or para-aramid fibers, such as Kevlar. This type of material provides the capability for very high tension with a small bend radius. Cords of other types of fibers may also be used, such as liquid crystal polymer (LCP) fibers, isotropic crystal polymer fibers, carbon fiber, ultra-high molecular weight polyethelene (UHMWPE), etc. The cord 222 can optionally be another material that has a high tensile strength (e.g., to support 200 lbs, 300 lbs, 400 lbs of tension or more), such as a steel cable, but the exosuit 100 would need to be designed to accommodate a larger bend radius. For example, a steel cable that can tolerate 200 pounds (lbs) of tension may have a minimum bend radius of approximately 3 inches. The use of aramid, para-aramid, or other types of fibers discussed above can provide sufficiently high tensile strength to support high tension while allowing a smaller minimum bend radius, such as less than about ¾ of an inch.

In the second stage 220, the cord segments 324a-324b each extend from the spool 320 distally from opposite sides of the spool 320. The cord segments 324a-324b extend substantially parallel to each other to corresponding guide pulleys 330a-330b that are part of the load cell assembly 230. From the guide pulleys 330a-330b, the cord segments 324a-324b continue to the end of the distal portion 120, which is formed as a pulley 340.

The pulley 340 at the end of the distal portion 120 has a channel 342 defined along its circumference to at least partially receive portions of the cord segments 324a-324b. The channel 342 provides a location for the cord segments 324a-324b to rest and also aligns the cord segments 324a-324b. The cord segments 324a-324b are each anchored to the pulley 340 at a corresponding anchor point 344a-344b. Each anchor point 344a-344b can be a fixed connection that holds the end of the corresponding cord segment 324a-324b fixed in place on the pulley 340 without slippage and can withstand high tension, e.g., several hundred pounds of force. As illustrated, the pulley 340 does not need to be a full circle, and may extend only partially along the end of the distal portion 120, for example, approximately a half circle. The edge defining the channel 342, which is the region that interacts with the cord segments 324a-324b, can be circular, but the remaining regions of the distal portion of the pulley can have other shapes. The joint 130 can include ball bearings to facilitate rotation of the distal portion 120 relative to the proximal portion 110.

The reduction of the second stage 220 is set by the relative diameters of the spool 320 and the pulley 340. The diameter of the spool 320 is much less than the diameter of the pulley 340. In the example illustrated, the spool 320 has a diameter of approximately ¾ of an inch, and the diameter of the pulley 340 is approximately 5 inches, resulting in a speed ratio of approximately 7:1.

Driving the motor 112 in different directions can cause flexion and extension. For example, turning the motor spindle 302 clockwise flexes the joint 130 by causing the drive pulley 310 and attached spool 320 to turn clockwise, which lets out cord 222 from the spool 320 to lengthen the cord segment 324a while winding more cord 222 onto the spool 320 to shorten the cord segment 324b. Similarly, turning the motor spindle 302 counterclockwise extends the joint 130 by causing the drive pulley 310 and attached spool 320 to turn counterclockwise, which winds on cord 222 onto the spool 320 to shorten the cord segment 324a while winding letting out cord 222 from the spool 320 to lengthen the cord segment 324b.

The exosuit 100 has the load cell assembly 230 placed near the pulley 340 on the distal portion 120. This allows the load cell assembly 230 to be located very close to joint 130 and the distal portion 120, downstream of most of the reduction and frictional losses in the transmission 114, which allows for more accurate measurement. The transmission 114 does cause some losses, but these can be calculated and compensated for. Sensing the applied forces at the end of the transmission 114 can be much more accurate than sensing torque just at the motor 112. At the motor 112, force still needs to be transmitted through the reduction stages 210, 220, and the amount of frictional loss that occurs can vary over time wear, temperature, and so on. Measuring closer to the ultimate point of application of the force to the joint 130 allows much better accuracy. In the example, the only frictional loss in the chain of force transmission after the load cell assembly 230 is the ball bearing in the joint 130, which is typically very small. Note that what is important is not that the load cell assembly 230 is spatially close to the joint 130, but that the load cell assembly 230 is near in the force transmission chain. In the example, there are no further reduction stages following the load cell assembly 230 that would affect sensing.

The load cell assembly 230 is designed to accurately sense forces applied through the cord segments 324a-324b, for example, to sense the magnitude and direction of differences in tension in the two cord segments 324a-324b. The load cell assembly 230 includes a load cell, such as a piezoelectric load cell, a spring with potentiometer, or other types of force sensor. The load cell can be configured to sense increases or decreases in force from an equilibrium position of zero net force on the load cell assembly.

The load cell assembly 230 is anchored to the housing of the exosuit 100 at one end (e.g., the proximal end) of the load cell assembly 230. For example, the proximal end can be rigidly fixed to a plate 360 of the proximal portion 110 (e.g., a plate 360 to which the motor 112 and post 312 are also rigidly mounted). The other end of the load cell assembly 230 is free and carries guide pulleys 330a-330b on opposite sides of the central portion of the load cell assembly 230. Forces on the guide pulleys 330a-330b, transmitted to the free, distal end of the load cell assembly 230, flex the main body of the load cell assembly 230 in an anterior or posterior direction. The fixed anchored end of the load cell assembly 230 resists movement, and a load cell along the superior-inferior length of the load cell assembly 230 measures the net force applied by the cord segments 324a-324b.

The guide pulleys 330a-330b are each configured to engage a different cord segment 324a-324b. For example, the cord segment 324a engages the guide pulley 330a, so that tension on the cord segment 324a applies a force on the guide pulley 330a in an anterior direction. The cord segment 324b engages the guide pulley 330b, so that tension on the cord segment 324b applies a force on the guide pulley 330b in a posterior direction. The tension on the cord segments 324a-324b thus applies opposing forces to the load cell assembly 230 through the interaction of the cord segments 324a-324b with the pulleys.

When the cord segments 324a-324b have equal tension, the forces that the cord segments 324a-324b apply to the two guide pulleys 330a-330b cancel each other out (e.g., at least the force components along the anterior-posterior axis cancel out), resulting in a net force of zero sensed by the load cell. When the net force on the load cell is non-zero, the load cell provides an measurement value that indicates the increase or decrease from the equilibrium state. A non-zero force measurement indicates that additional force is being applied, for example, due to application of the motor to cause a movement (e.g., to assist a user to stand up from a sitting position) or due to user input attempting to initiate a movement (e.g., a user applying a force when the motor is not activated so the user can start moving the leg).

The arrangement of the load cell to be affected by both tension in both cord segments 324a-324b helps increase the responsiveness of the system. Force applied by the wearer 102 is sensed in both cord segments 324a-324b, e.g., simultaneously increasing tension in one while decreasing tension in the other, allowing for a differential measurement that enhances sensitivity in the load cell.

As will be discussed further below, the control system of the exosuit 100 can attempt to maintain the net force detected by the load cell at zero when the motor is not being driven to perform a movement or hold a position. For example, if the control system detects that the wearer 102 is sitting and support by the exosuit 100 is not needed, the control system can detect even small deviations from zero net force as attempts by the wearer 102 to move the leg, and the control system can responsively drive the motor 112 to facilitate those movements and avoid resisting the wearer's attempts to move.

During active movements or support (e.g., standing) powered by the exosuit 100, the net force sensed by the load cell often will not be zero. Nevertheless, the control system 110 can be calibrated with values representing the appropriate force values and force patterns expected for different movements and activities (e.g., taking a step up stairs, walking on a flat surface, standing, etc.). Using the calibrated or historical force levels as a baseline, the control system can store reference values indicating the load cell measures expected for different activities, situations, and motor drive signals. The control system can compare the actual load cell measurements with the reference values for the situation. Based on the comparison result, the control system can determine whether the load cell measurement is appropriate for the current activity and motor drive signal. When the load cell measurement deviates from the expected level, the control system can detect that the user is providing resistance to the movement the exosuit 100 is attempting to perform. Depending on the situation, the control system can reduce or end support, or change support to perform a different activity.

The control system for the exosuit 100 can use a variety of sensors in combination with the load cell in the load cell assembly 230. For example, encoders can be included to sense the rotational position and amount of rotations that occur at the motor 112 and the joint 130. Various sensors can also be included to sense the angle of components relative to the ground, to sense the inclination or angle of the proximal portion 110, the distal portion 120, or both. The exosuit 100 may include one or more cameras that can detect surroundings. Similarly, the exosuit 100 may include accelerometers, inertial measurement units (IMUs), or other motion sensors. All of these sensors can be used by the control system to detect the context of the exosuit 100, to determine the current conditions of the exosuit 100, and to use in estimating the desired activity the wearer 102 intends to perform, so the control system can better select an appropriate control profile or set of motor signals to support the current activity.

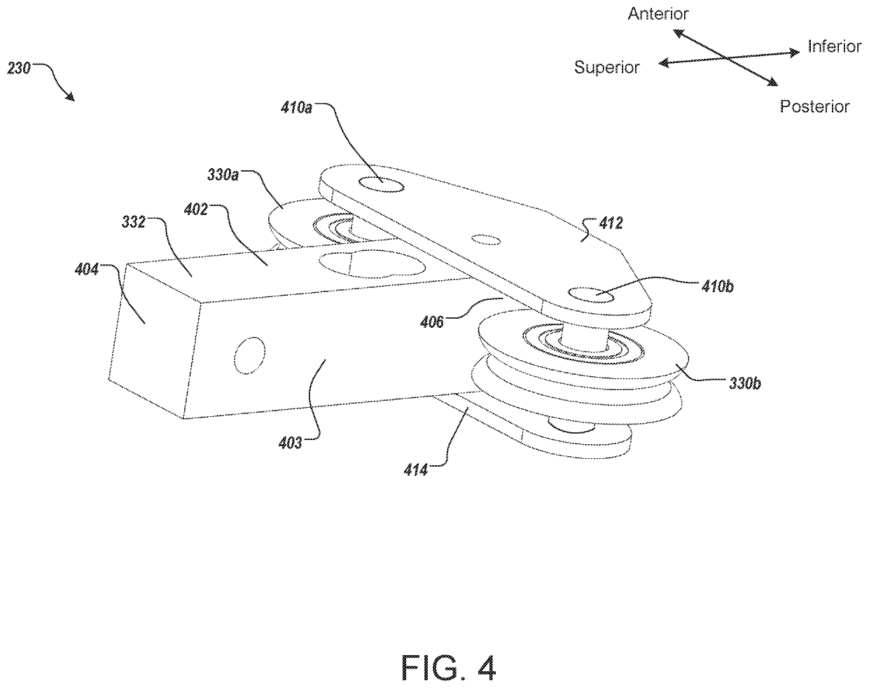

FIG. 4 is a perspective view of the load cell assembly 230. The load cell assembly 230 includes a center portion 402 that includes the load cell 403 (e.g., one or more load cells or other sensing components). The center portion 402 extends with its length (e.g., from a proximal end 404 to a distal end 406) substantially aligned along the superior-inferior axis. The load cell 403 is oriented to primarily sense force components applied along the anterior-posterior axis, e.g., in directions substantially perpendicular to the length of the central portion 402. In the assembled exosuit 100, the proximal end 404 is rigidly mounted to the housing of the exosuit 100 at an anchor 332, while the remainder of the load cell assembly 230 is left unconnected from the housing. As a result, the central portion 402 can flex along its length in response to forces applied by the cord segments 324a-324b on the guide pulleys 330a-330b.

The guide pulleys 330a-330b each rotate about corresponding pulley shafts (e.g., an axle or pin), around which ball bearings or other low-friction connections are provided. The pulley shafts 410a-410b are held in place by an upper plate 412 and a lower plate 414, which are both rigidly connected to the central portion 402. As a result, the net force in an anterior or posterior direction applied on the guide pulleys 330a-330b the by the cord segments 324a-324b is sensed by the load cell 403.

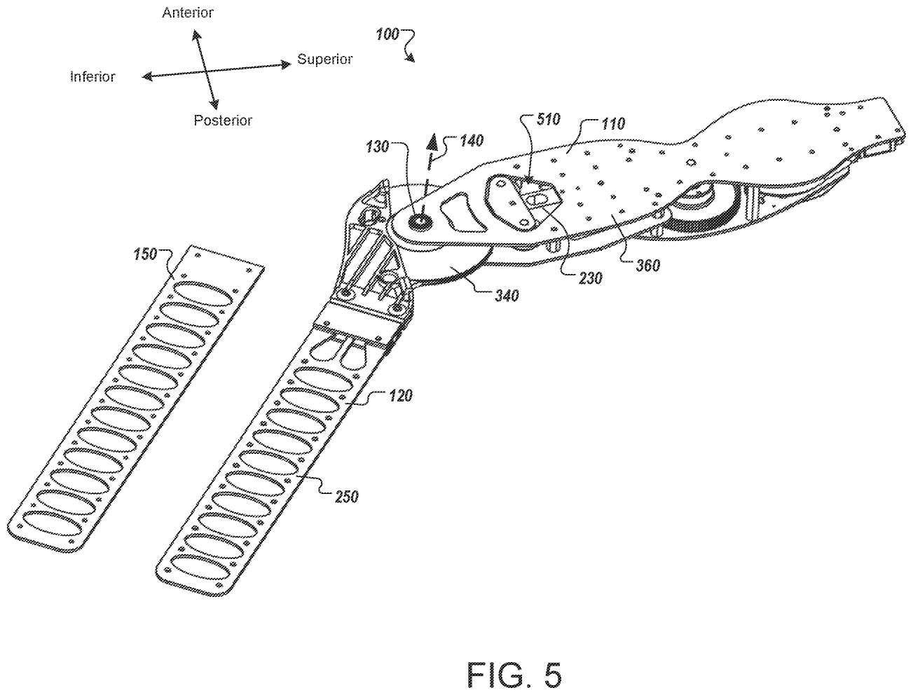

FIG. 5 is a bottom perspective view of the exosuit 100. This view shows the lateral side of the housing of the exosuit 100 which faces toward the wearer's leg. The plate 360 defines a cutout 510 that provides clearance for the distal end of the load cell assembly 230 to flex along its length toward the anterior or posterior directions.

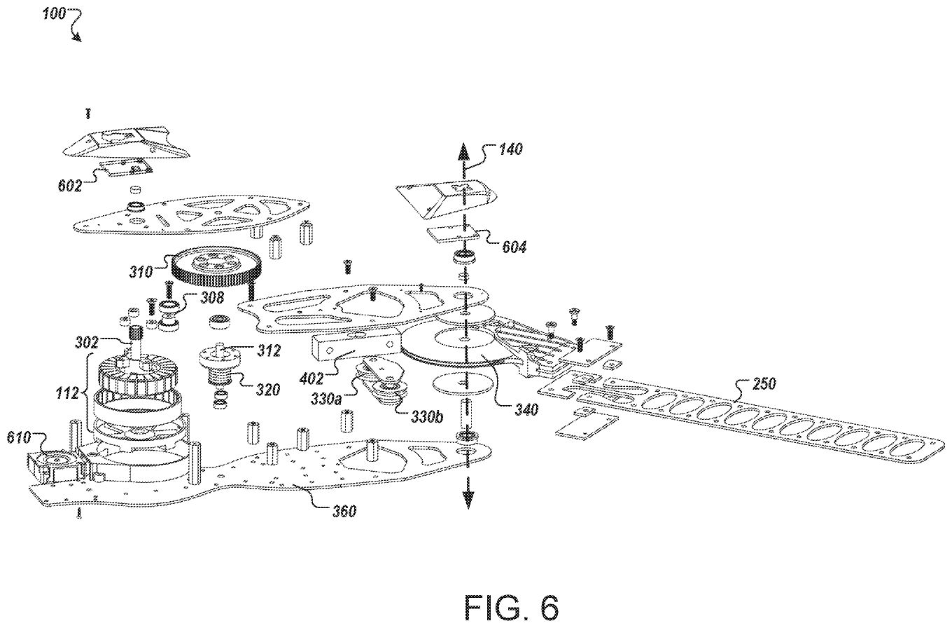

FIG. 6 is an exploded view of the exosuit 100, excluding the belt 304 and the cord 322. The exploded view shows locations of components discussed above, as well as components such as an encoder 602 to measure rotation of the motor spindle 302 and an encoder 604 to measure rotation of the pulley 340. In the exosuit 100, electronics 610, including a battery and control system, can be placed at the proximal end of the proximal portion 110.

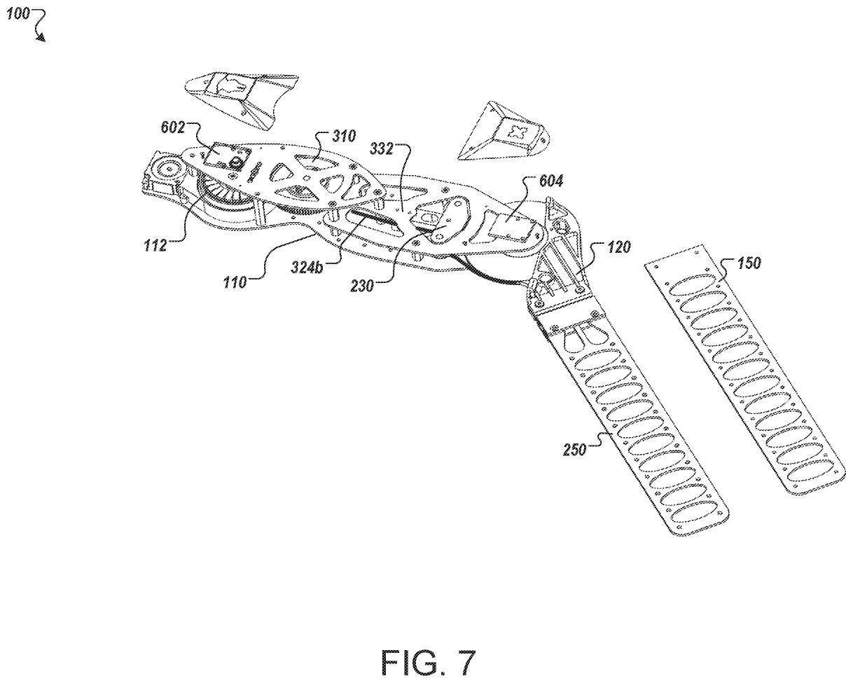

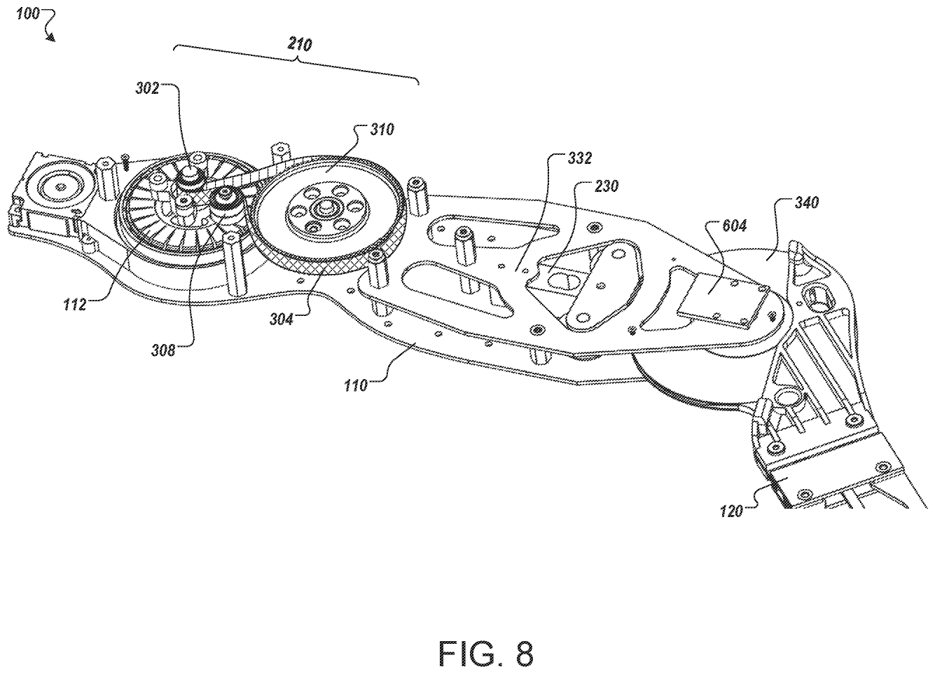

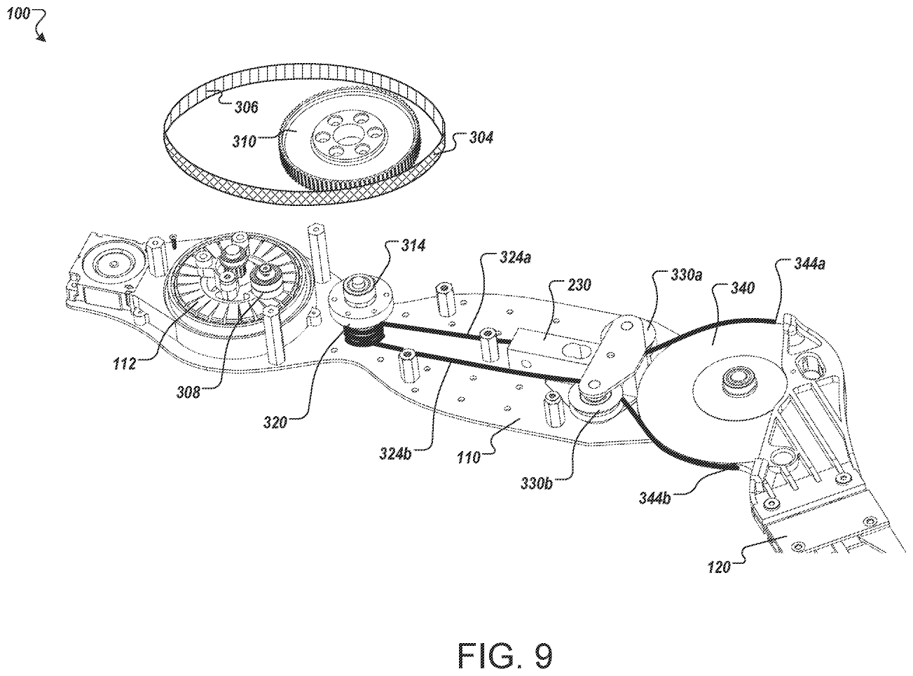

FIGS. 7-9 are a partial exploded view of the exosuit 100, showing additional views of the components of the exosuit 100.

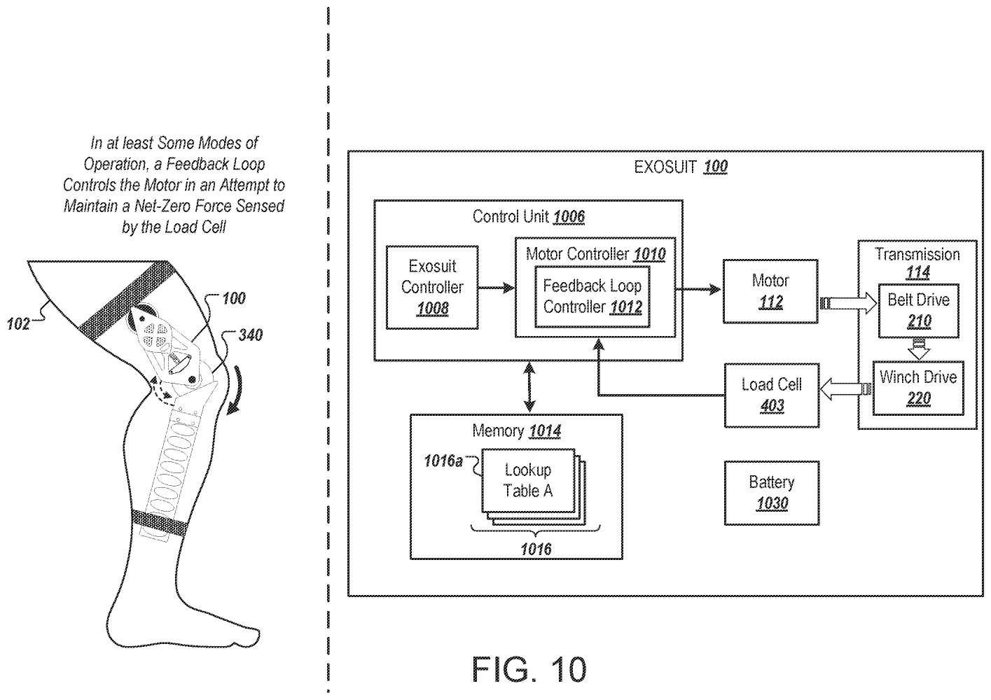

FIG. 10 depicts the exosuit 100 and various elements that can be used to control the exosuit 100, including elements providing a feedback loop using input from a load cell of the exosuit 100. The exosuit 100 is shown being worn by a wearer 102 and is configured to support the wearer 102's right leg. The exosuit 100 is configured to apply force to assist movement of a joint of the wearer 102, such as the wearer 102's right knee. When the exosuit 100 is not being driven to provide assistance, the control system of the exosuit 100 actively drives the motor 112 to reduce the mechanical resistance that the exosuit 100 presents to the user, in order to avoid impeding movements that the wearer 102 desires to perform. During operation of the exosuit 100, a feedback loop is used to approach and maintain a target level of force occurring a particular location of the exosuit 100 or of the wearer 102, such as at the knee joint of the wearer 102.

This specification describes technologies for controlling exosuits using a control system that includes a feedback loop, such as a proportional-integral-derivative controller, that can be set by an exosuit controller of the control system to target a particular net force or a net-zero force at a sensing device of the exosuit that is configured to detect both flexion and extension forces. The feedback loop can be implemented onboard the exosuit on an electronic device such as a computer processor and be used to control a motor of the exosuit. The sensing device can be, for example, a load cell that is configured to sense both flexion and extension forces produced by the exosuit, the wearer of the exosuit, or a combination of the exosuit and the wearer. The sensing device can be configured to output a net of the flexion and extension forces, such as the difference between the flexion and extension forces. The flexion or extension forces produced by the exosuit can include forces introduced by the motor of the exosuit being driven or forces introduced by mechanical resistance when a user attempts to manipulate the exosuit and backdrive the motor. The flexion or extension forces introduced by the wearer can be forces introduced when a wearer extends their appendage that the exosuit is fitted to, attempts to extend their appendage, flexes their appendage, or attempts to flex their appendage. The feedback loop can receive signals from the sensing device and respond by providing control instructions to the motor to target the particular net force or net-zero force at the sensing device.

The exosuit can have a drive system that includes the motor and a multi-stage force transmission mechanism. To minimize weight and provide a low profile, the exosuit can include a small, lightweight motor that is, for example, directly controlled by the feedback loop. The motor can rotate at a high speed, and the transmission mechanism can provide a speed reduction to allow for high torque to be applied at a joint of the wearer. The first stage of the transmission can be a belt drive, which operates much more quietly than a gearbox. The second stage can be a winch or capstan drive with anchored cables, e.g., with the cable(s) having an anchor at a fixed position of the spool of the winch. The winch is also very quiet, and can transmit very large torques, limited mainly by the tensile strength of the cable used. Together, the two stages of the transmission can greatly reduce rotational speed and increase torque with low weight, low noise, and a very low profile.

The sensing device of the exosuit can be configured to sense forces very close to the joint of the wearer, allowing high accuracy and sensitivity through placement after most or all of the speed reduction by the transmission has occurred and after most of the frictional losses in the drive system. For example, a load cell can be part of an assembly that is placed between two cord segments of the winch drive, which apply opposing forces to the load cell. One end of the load cell assembly can be anchored to the housing or internal structure of the exosuit, with another end being unanchored and free to be influenced by the two cord segments so that the load cell can flex or experience strain along its length. The cord segments can both apply their forces to the load cell through pulleys coupled to the load cell, allowing the load cell to sense a combination of the forces from the cord segments.

In some implementations, the exosuit is an exosuit fitted to one or more appendages of a wearer that have a joint. For example, the exosuit can be fitted to a leg of the wearer, both legs of the wearer, an arm of the wearer, or both arms of the wearer. In more detail, the exosuit can be an exosuit configured to support a knee joint of the wearer and provide the wearer assistance in bending and extending their leg. The sensing device can, for example, generate output that indicates net flexion and extension forces acting on the wearer's knee joint. As another example, the exosuit can be an exosuit configured to support an elbow joint of the wearer and provide the wearer assistance in bending and extending their arm.

In some implementations, the exosuit is an exosuit fitted to a portion of a wearer's body other than an appendage. For example, the exosuit can be fitted to a back of the wearer. The flexion or extension forces introduced by the wearer can be forces introduced when a wearer extends or straightens their back that the exosuit is fitted to, attempts to extend or straighten their back, flexes or bends their back, or attempts to flex or bend their back.

The exosuit controller can make high-level or intelligent determinations for controlling the exosuit, such as identifying a particular scenario indicative of an action that a wearer has started to perform or is attempting to perform. For example, different scenarios that the exosuit controller can detect can include standing from a sitting position, walking, climbing stairs, jumping, jogging, running, sitting, leaning, laying down, standing, or the like. The exosuit controller can refer to, for example, a data object, control program, or control protocol for each of the scenarios that specifies a target force for the feedback loop or a set of target forces for the feedback loop. The data object, control program, or control protocol can also specify durations that the target forces should be set for before new target forces are provided by the exosuit controller. Determining the scenarios can be computationally complex and, therefore, may require more computation time. However, by having the exosuit controller separate from the feedback loop, the feedback loop is able to quickly generate new motor control signals based on the last set target force and the output of the sensing device.

The exosuit controller can continually change the target force for the feedback loop based on detected scenarios and corresponding data objects, control programs, or control protocols. For example, when the exosuit controller detects a first scenario of a wearer attempting to stand from a sitting position, the exosuit controller can change the target force for the feedback loop from net-zero force to 40 lbs in accordance with a standing program or protocol. After one second and multiple feedback loop cycles have passed, the exosuit controller can change the target force for the feedback loop from 40 lbs to 20 lbs in accordance with the standing program. When the exosuit controller detects a new scenario of the wearer reaching a standing position, the exosuit controller can, for example, change the target force from 20 lbs back to a net-zero force.

In certain scenarios, the exosuit controller can set the target force for the feedback loop to a net-zero force in order to avoid impeding the natural movement of the wearer. For example, the exosuit controller can set a net-zero force when the wearer is detected to be in a neutral state such that the wearer does not require powered assistance from the exosuit. Due to the high speed ratio between the rotation of the motor and the rotation of the knee joint, the exosuit has the potential to provide a high level of resistance (e.g., high reflected inertia or load) to the wearer when the wearer attempts to actuate the joint. To avoid presenting this resistance from the wearer, the exosuit can use the sensing device to detect forces applied by the wearer and use the feedback loop to actively drive the motor of the exosuit to move the joint in response. The sensing device, such as a load cell, can provide high responsiveness and high accuracy, so the exosuit can initiate movement with a relatively low force threshold. This allows the feedback loop of the exosuit to respond quickly to small movements of the wearer by driving the motor, so as not to impede intended movements of the wearer.

The exosuit controller can determine that a wearer of the exosuit is in a neutral state when exosuit controller determines that the wearer is in a particular position or performing a particular action. For example, the exosuit controller can determine that the wearer is in a neutral state based on a determination that the wearer is sitting, lifting a leg that the exosuit is fitted to, leaning, or standing.

As an example, a wearer of the exosuit may be sitting down and may attempt to move their foot backward, perhaps to position their foot before standing up or even just allowing knee to bend freely to swing the foot back and forth. In this situation, the control system can hide the high reflected inertia that the wearer faces due to the high reduction ratio from the motor to the knee joint. In other words, when the wearer applies force to initiate flexion, the apparent resistance sensed by the wearer is low because the feedback loop actively drives the motor to bend the joint. For example, a user's force toward flexion increases tension in the upper cord segment and increases the force the upper cord segment applies on the load cell, while the same force by the user decreases tension in the lower cord segment and decreases the force the lower cord segment applies on the load cell. The feedback loop responds by gradually driving the motor to compensate for this change in net force on the load cell, by driving the motor to flex the knee. The characteristics of the motor drive signals, e.g., the direction, speed, duration, and extent of motor activation, can be set based on the parameters of the feedback loop and the characteristics of the load cell signal over time (e.g., whether net force increases or decreases from the equilibrium point, the magnitude of change from the equilibrium point, the rate or pattern with which the load cell signal changes, how long the deviation from equilibrium persists, etc.).

The subject matter described in this specification can be implemented in particular embodiments so as to realize one or more of the following advantages. For example, the described techniques can improve control systems for exosuits to achieve improved response times, wearer comfort, and wearer safety. In more detail, by using a feedback loop that receives signals from a highly responsive and highly accurate sensing device configured to sense a combination of extension and flexion forces from cord segments, the control system can initiate movement with a relatively low force threshold and respond quickly to small movements of the wearer by driving the motor through the feedback loop. This responsiveness allows the control system to leverage the force advantages that a high speed ratio transmission provides while reducing the negative effects of a high speed ratio transmission, such as significant mechanical resistance when a wearer attempts to backdrive the motor by manipulating the exosuit, by quickly driving the motor in a manner so as not to impede intended movements of the wearer. As a result of the responsiveness that the control system provides, the control system can achieve (i) significantly improved wearer comfort as the wearer will not need to struggle with manipulating the exosuit and will not feel as if they are fighting the exosuit when they attempt to flex or extend the exosuit and (ii) improved wearer safety as it will be significantly less likely that a wearer will incur an injury when the powered assistance provide by the exosuit is highly responsive to the wearer's movements and forces.

As discussed above, the exosuit 100 includes components including a control unit 1006, a memory 1014, a motor 112, a transmission 114, a load cell 403, and a battery 1030. The control unit 1006 includes components for two levels of control. An exosuit controller 1008 is configured to perform high-level functions such as detecting the type of activity to perform and to process data from sensors such as cameras, accelerometers, encoders, and so on. A motor controller 1010 provides lower level control, receiving instructions from the exosuit controller 1008 and providing drive signals or motor commands to drive the motor 112. The exosuit controller 1008 provides instructions regarding movements to perform or forces to provide, and the motor controller 1010 provides a very fast, very responsive mechanism to ensure that the motor 112 delivers the amount of force instructed by the exosuit controller 1008. The motor controller 1010 can also control the motor 112 to actively respond to wearer-applied forces to position the exosuit 100 as the wearer intends.

The motor controller 1010 uses a feedback loop controller 1012. The control unit 1006 can communicate with the memory 1014 that includes, for example, a set of lookup tables 1016. The feedback loop controller 1012 of the motor controller 1010 can receive outputs from the load cell 403 and generate motor control signals for the motor 112, such as pulse width modulation (PMW) signals, based on the outputs of the load cells 128. The motor 112 is mechanically coupled to the transmission 114 that includes a first stage having a belt drive 1110 and a second stage having a winch drive 220. The load cell 403 is configured to measure the force or combination of forces applied by and/or to (e.g., applied by the wearer 102) the second stage of the transmission 114.

The exosuit 100 can be operated so as to hide or reduce the presence of the exosuit 100 from the perspective of the wearer 102. For example, a set point for the feedback loop controller 1012 can be selected so that the apparent force provided by the exosuit 100 or the mechanical resistance introduced by the exosuit 100 approaches zero at a joint of the wearer 102. As a result of approaching zero force or resistance at the wearer 102's joint, the exosuit 100's operation becomes substantially transparent to the wearer 102. The exosuit 100 can also be operated in modes other than the transparent mode. For example, the exosuit 100 can be controlled by the motor controller 1010 using the feedback loop controller 1012 to approach and apply a target force at a joint of the wearer 102. This can be helpful to provide the wearer 102 assistance in various scenarios, such as when the wearer 102 attempts to stand up or climb stairs. In these scenarios, the exosuit controller 1008 can refer to a data object, program, or protocol for the scenario that indicates different target forces to set for the motor controller 1010, durations that the target forces should be set for, or both.

The feedback loop controller 1012 can be a closed-control loop that uses a control algorithm to generate motor control signals for the motor 112. This control algorithm can be, for example, a proportional-integral-derivative (PID) controller, a proportional-integral (PI) controller, a proportional-derivative (PD) controller, a proportional (P) controller, an integral (I) controller, or a derivative (D) controller. The control algorithm used by the feedback loop controller 1012 can include one or more variables that are preset to be constants during operation. For example, the feedback loop controller 1012 can be a PID controller that includes a preset proportional gain and a preset integral gain. Additionally or alternatively, the control algorithm can include one or more variables that can change value during operation. For example, the feedback loop controller 1012 can include a PID controller that includes a preset proportional gain and a variable integral gain that depends on a level of assistance that the exosuit 100 is set to provide or a selected setpoint for the feedback loop controller 1012.

The different control algorithms can provide different benefits that may result in better operation of the exosuit 100 for different situations. For example, in scenarios where a high level of assistance is needed which may require a high output torque from the motor 112 (e.g., output torque greater than 5.0 N·m, greater than 10 N·m, greater than 15 N·m, etc.), a PID controller can be selected by the motor controller 1010 for the feedback loop controller 1012 over a PI controller due to the PID controller providing better maximum peak overshoot than the PI controller. By selecting a control algorithm that reduces the maximum peak overshoot when the level of assistance is at or greater than a threshold level of assistance, the probability of the wearer 102 being injured is reduced as the likelihood of the motor 112 applying too much torque to transmission 114 (e.g., and ultimately to a joint of the wearer 102) is reduced and the probability of the exosuit 100 being damaged by the motor 112 applying too much torque to transmission 114 is also reduced. As another example, in scenarios where the setpoint for the control algorithm is changing or expected to change based on one or more factors such as the most recent output of the load cell 403, the feedback loop controller 1012 can use a PI controller or a PID controller instead of a PD controller due to the risk of a derivative kick introduced by changing setpoints when using a PD controller.

Other factors may also be considered in determining the particular control algorithm or type of control algorithm for the feedback loop controller 1012. These other factors can include the type of exosuit (e.g., leg-support exosuit, arm support exosuit, back support exosuit, etc.), characteristics of the wearer 102 (e.g., age, weight, height, sex, etc.), or the type of disability or injury that the exosuit 100 is helping the wearer 102 manage. For example, when the exosuit 100 is an exosuit for the wearer 102's leg as shown in FIG. 10, a PID controller or a D controller can be selected for the feedback loop controller 1012 due to the leg application requiring faster response times that the PID controller and D controller can provide when compared to other control algorithms such as an I controller and a PI controller.

In generating a motor control signal for the motor 112 using a control algorithm, the feedback loop controller 1012 can calculate an error using a setpoint and the most recent output of the load cell 403. The calculated error can serve as a variable in the control algorithm for generating a motor control signal. For example, the feedback loop controller 1012 can include a PID controller that outputs a PID control variable based on the calculated error value. The PID control variable can serve as a motor control signal that is provided directly from the feedback loop controller 1012 to the motor 112. Alternatively, the motor controller 1010 can convert the PID control variable into a motor control signal for the motor 112. As will be discussed in more detail below, the setpoint can be a level of assistance described in more detail below, a desired force or torque measurement at a particular location on the exosuit, and/or a desired output of the load cell 403.

As an example, the feedback loop controller 1012 can calculate the error by taking the difference between a desired output of the load cell 403 of 5.0 V and the most recent output of the load cell 403 of 4.2 V. The error of 0.8 V can then be converted into a motor control signal for the motor 112 that is expected to cause the motor to introduce a force into the transmission 114 that results in a load cell 403 measuring a different force that results in an output of 5.0 V or results in an output that is closer to 5.0 V than the immediately preceding output of the load cell 403.

As another example, the feedback loop controller 1012 can calculate the error by taking the difference between a desired force experienced at the load cell 403 of 3.5 N and the most recent force measured at the load cell 403 of 2.5 N. Prior to calculating the error, the motor controller 1010 or the feedback loop controller 1012 may, for example, convert the most recent output of the load cell 403 (e.g., a voltage value) to a force experienced at the load cell 403.

In some implementations, the feedback loop controller 1012 does not use a control algorithm to generate the motor control signals for the motor 112. For example, as will be discussed in more detail below, the feedback loop controller 1012 can fetch commands for the motor 112 or parameters used to generate motor signals from a lookup table based on the most recent output of the load cell 403.

In some implementations, the feedback loop controller 1012 always uses a control algorithm. For example, the feedback loop controller 1012 may always use a PID controller or a PI controller to generate motor control signals for the motor 112.

The feedback loop controller 1012 can be a digital control loop. For example, the motor controller 1010 can be pre-programmed with a digital PID controller that serves as the feedback loop controller 1012. As another example, based on control instructions received from the exosuit controller 1008, the motor controller 1010 can select one of multiple pre-programmed control loops that can serve as the feedback loop controller 1012. In more detail, in response to receiving control instructions from the exosuit controller 1008 providing that the level of assistance is two, the motor controller 1010 can select a pre-programmed PI controller to serve as the feedback loop controller 1012. If instead the motor controller 1010 receives instructions providing that the level of assistance is one, the motor controller 1010 can select a different pre-programmed PI controller that, for example, has different parameter values for the proportional gain and/or the integral gain.

The feedback loop controller 1012 can be an analog control loop. The motor controller 1010 can include one or more dedicated circuits for the feedback loop controller 1012. For example, the motor controller 1010 may contain a first analog circuit that is an analog PID controller and a second analog circuit that is an analog PI controller. The motor controller 1010 can contain a digital or analog switch, such as a MOSFET, to select between the two analog circuits depending on, for example, the current level of assistance set for the exosuit 100 or a selected setpoint for the feedback loop controller 1012.

In some implementations, the feedback loop controller 1012 includes uses multiple control algorithms. The feedback loop controller 1012 can include multiple loops that each use a control algorithm. For example, the feedback loop controller 1012 can use two PI controllers, a first PI controller that is used to achieve a set amount of torque from the motor 112 based on current feedback and a second PI controller that is cascaded with the first PI controller (e.g., second PI controller forms an outer loop and the first PI controller forms an inner loop) to achieve a set amount of force experienced at the load cell 403 based on feedback from the output of the load cell 403.

As will be discussed in more detail with respect to FIGS. 2A-2B, the feedback loop controller 1012 can be a closed-loop control loop that only uses feedback from a sensor. For example, the feedback loop controller 1012 may use the output of the load cell 403 as its only feedback.

As will be discussed in more detail with respect to FIGS. 3A-3B, the feedback loop controller 1012 can be a closed-loop control loop that uses feedback from a sensor and other information to generate motor control signals. For example, the feedback loop controller 1012 may use the output of the load cell 403 as feedback and the immediately preceding motor control signal provided to the motor 112 to generate a new motor control signal for the motor 112.

The exosuit controller 1008 can make high-level or intelligent determinations for controlling the exosuit 100. For example, the exosuit controller 1008 can use the outputs of various sensors, one or more machine learning models, and/or historical data to identify an action that the wearer 102 is performing or attempting to perform and, in response, determine instructions for the motor controller 1010 to control the motor 112. The instructions provided by the exosuit controller 1008 to the motor controller 1010 can indicate a level of assistance that is to be provided by the exosuit 100 to the wearer 102. The level of assistance can serve as a setpoint for the feedback loop controller 1012 or be used by the motor controller 1010 to lookup a setpoint for the feedback loop controller 1012. For example, as will be described in more detail with respect to FIGS. 2A-2B, if the exosuit controller 1008 provides instructions to the motor controller 1010 that set the level of assistance to zero, the motor controller 1010 can, in response, set the setpoint for the feedback loop controller 1012 to zero.

The instructions sent by the exosuit controller 1008 can specify a particular control algorithm or a particular type of control algorithm for the feedback loop controller 1012. The instructions can explicitly identify the control algorithm or type of control algorithm for the feedback loop controller 1012 to use, or can include information (e.g., the indication of the level of assistance) that the motor controller 1010 can use to identify the control algorithm or type of control algorithm. For example, the instructions sent by the exosuit controller 1008 to the motor controller 1010 can specify that the feedback loop controller 1012 should use a pre-programmed PID controller to generate motor control signals for the motor 112.

The instructions sent by the exosuit controller 1008 can specify a particular lookup table of the lookup tables 1016 for the motor controller 1010 to access. The instructions can explicitly identify the lookup table or can include information (e.g., the indication of the level of assistance) that the motor controller 1010 can use to identify the lookup table from among the lookup tables 1016. For example, the instructions sent by the exosuit controller 1008 to the motor controller 1010 can specify that a lookup table 1016a should be accessed by the motor controller 1010 and be used to generate motor control signals for the motor 112.

In some implementations, the motor controller 1010 uses the instructions from the exosuit controller 1008 to select a control algorithm and to access a lookup table. For example, in response to the level of assistance being set to two, the motor controller 1010 can identify a particular control algorithm to use and a particular lookup table to access.

The level of assistance can be used by the motor controller 1010 to access a particular data object from the memory 1014, to select a particular control algorithm for the feedback loop controller 1012, or both. For example, a level of assistance of zero can be associated with a particular lookup table 1016a (“Lookup Table A”) of the lookup tables 1016. In response to receiving instructions from the exosuit controller 1008 that the assistance level is set to zero, the motor controller 1010 can access the lookup table 1016a and use it to identify values to use in generating a motor signal to the motor 112. As another example, the level of assistance of zero can be associated with a particular type of control algorithm, such as a PID control algorithm. In response to receiving instructions from the exosuit controller 1008 that the assistance level is set to zero, the motor controller 1010 can set the control loop 112 to use a predetermined PID control algorithm with a specified setpoint associated with the level of assistance.

The level of assistance can additionally or alternatively represent a setpoint for the feedback loop controller 1012. For example, the level of assistance can represent a desired output for the load cell 403, where the error used to generate a motor control signal for the motor 112 is calculated using a difference between the setpoint and the output value from the load cell 403. In more detail, if the level of assistance is set to zero, then the desired load cell 403 output value can be set to 0 V. The motor controller 1010 can proceed to use the feedback loop controller 1012 to adjust the output of the motor 112 (e.g., torque output) if the most recent output of the load cell 403 deviates from the desired 0 V.

The level of assistance can be used by the motor controller 1010 to lookup a particular setpoint or list of setpoint. For example, in response to receiving instructions that set the level of assistance to one, the motor controller 1010 can access a lookup table from the lookup tables 1016 that includes a list of setpoints based on the level of assistance, where each setpoint in the list corresponds to a particular value or ranges of values of the most recent load cell output from the load cell 403.

The level of assistance can represent or indicate a desired amount of torque or force to be experienced at a particular location of the exosuit 100 or of the wearer 102. For example, the level of assistance can represent a desired amount of torque that is to be detected at the location of the load cell 403 or the location of a joint of the wearer 102 (e.g., location of the center of rotation of the wearer 102's right knee). In more detail, if the level of assistance is set to one, then the desired force experienced at the center of rotation of the joint of the wearer 102 can be set to 1.0 Nm. The desired force can be used as a setpoint for the feedback loop controller 1012. Alternatively, the desired force can be used to calculate the desired force at location of the load cell 403, where the calculated value can be used as a setpoint for the feedback loop. Alternatively, the desired force can be used to calculate the desired force at location of the load cell 403 and converted by the control unit 1006 into a desired output of the load cell 403, where the desired output can be used as a setpoint for the feedback loop controller 1012. As another example, if the level of assistance is set to one, then the desired force experienced at the load cell 403 can be set to 1.0 Nm. The desired force can be used as a setpoint for the feedback loop controller 1012. Alternatively, the desired force can be converted by the control unit 1006 into a desired output of the load cell 403, where the desired output can be used as a setpoint for the feedback loop controller 1012.

The motor controller 1010 can use the instructions from the exosuit controller 1008 to access one or more data objects from the memory 1014. The data objects can include, for example, a lookup table from the lookup tables 1016. For example, in response to receiving instructions from the exosuit controller 1008 that sets the assistance level to zero, the motor controller 1010 can access a lookup table 1016a (“Lookup Table A”) from the lookup tables 1016 that is associated with the Assistance Level 0.

The lookup tables 1016 can include lookup tables that contain control signals for the motor 112 or parameters for control signals for the motor 112. For example, as will be discussed in more detail with respect to FIGS. 2A-2B, the lookup table 1016a can include parameters such as voltages and corresponding duty cycles that are associated with particular outputs of the load cells 128 or ranges of outputs of the load cells 128. The feedback loop controller 1012 of the motor controller 1010 can use the lookup table 1016a to select a voltage and a duty cycle based on the most recent output of the load cells 128. The motor controller 1010 can then generate a PWM control signal for the motor 112 using the selected voltage and duty cycle.

When using a lookup table that contains control instructions for the motor 112 or parameters for motor control signals for the motor 112, the feedback loop controller 1012 may not use or include a control algorithm. For example, the feedback loop controller 1012 can be operated continually to select motor control signals or signal parameters for the motor 112 from the lookup table using the most recent outputs of the load cell 403.

A lookup table of the lookup tables 1016 can contain other parameters that are used to generate motor control signals. As an example, the feedback loop controller 1012 may be a PID controller having a control algorithm that includes a number of variables including a proportional gain, an error value defined as a difference between a setpoint and a measured process variable (e.g., output of the load cell 403), an integral gain, a change in error value, and a change in time value. The setpoint for the PID controller can be selected by the exosuit controller 1008, e.g., directly or indirectly through the level of assistance selected by the exosuit controller 1008 and provided to the motor controller 1010 in the most recent control instructions. In addition to the PID controller, the feedback loop controller 1012 may also use a lookup table from the lookup tables 1016 that provides a list of parameter values for the control algorithm of the PID controller relates the list of values to some other set of values. For example, a lookup table may contain a list of different proportional gains and/or integral gains to use in the control algorithm for the PID controller. The lookup table can relate these gains to, for example, the most recent output of the load cell 403, the most recently calculated error (e.g., the difference between the most recent output of the load cell 403 and the setpoint determined from the current level of assistance), or the immediately preceding calculated error (e.g., the calculated error that was used in to generate the last motor control signal provided to the motor 112).

The lookup tables 1016 can include a lookup table that includes a list of particular control algorithms or particular types of control algorithms for the feedback loop controller 1012. These control algorithms can serve as the feedback loop controller 1012 or be used as part of the feedback loop controller 1012. As an example, a lookup table can relate different instructions from the exosuit controller 1008, such as different levels of assistance provided in the control instructions from the exosuit controller 1008, to different control algorithms or different types of control algorithms. These control algorithms can include one or more types of control algorithms, such as one or more PID controllers, PI controllers, and/or P controllers. The control algorithms can include multiple control algorithms of the same type, such as multiple PID controllers that each have different proportional gains and/or integral gains.

The lookup table that indicates a particular or type of control algorithm for the feedback loop controller 1012 to use can also or alternatively provide an indication of one or more other lookup tables for the feedback loop controller 1012 to use. For example, in response to receiving control instructions from the exosuit controller 1008, the motor controller 1010 may refer to a first lookup table before accessing any other lookup tables. The first lookup table may provide that the feedback loop controller 1012 should use the lookup table 1016a to control the motor 112 without a control algorithm when the level of assistance is set to 0, use a PID control algorithm for the feedback loop controller 1012 when the level of assistance is set to 1, and use a PI control algorithm for the feedback loop controller 1012 when the level of assistance is set to 2.

The lookup tables 1016 can include lookup tables that contain a list of setpoints for the feedback loop controller 1012. For example, the lookup tables 1016 can include a lookup table that contains a list of setpoints that correspond to different outputs of the load cell 403. Based on the most recent output from the load cell 403, the motor controller 1010 can select a particular setpoint to use for the control algorithm of the feedback loop controller 1012. The feedback loop controller 1012 can proceed to generate control motor signals for the motor 112 using the setpoint identified from the lookup table.

As another example, the lookup tables 1016 can include a lookup table that contains a list of setpoints that correspond to different levels of assistance. In response to receiving instructions from the exosuit controller 1008, the motor controller 1010 can extract a level of assistance from the instructions and access this lookup table. The motor controller 1010 can then identify a setpoint from the lookup table that is related (e.g., positionally related, linked, shares a label with, etc.) to the extracted level of assistance. The feedback loop controller 1012 can proceed to generate control motor signals for the motor 112 using the setpoint identified from the lookup table.

The lookup tables 1016 can include a conversion table. For example, the lookup tables 1016 can include a table that the motor controller 1010 can use to convert outputs of the load cell 403 to a force. The table may contain, for example, a first column that includes non-overlapping values or ranges of values for outputs of the load cell 403 and a second column that includes values that represent forces indicated by the outputs of the load cell 403. As an example, the motor controller 1010 may first convert the output of the load cell 403 to a force using this table and then provide the force value to the feedback loop controller 1012. The feedback loop controller 1012 can use the force value and a setpoint to determine an error.

In some implementations, the lookup tables 1016 include multiple types of lookup tables. For example, the lookup tables 1016 can include a first lookup table that includes a list of setpoints that is obtained by the motor controller 1010 when the level of assistance is set to two, and a second lookup table that includes a list of motor control signal parameters and corresponding outputs or output ranges of the load cell 403.

The motor 112 can be electric motor. The motor 112 can be a DC motor, such as a DC shunt motor, or an AC motor, such as an induction motor. The motor 112 can be a servo motor. For example, the motor 112 can be a DC servo motor.

The motor 112 can be a brushed or brushless motor. For example, the motor 112 can be a brushless DC motor that uses one or more Hall effect sensors to determine rotor position and control the energizing of stator windings.

In some implementations, the motor 112 is an actuator. For example, the motor 112 can be a linear magnetic actuator that applies a linear force to the transmission 114.

In some implementations, the exosuit 100 includes multiple electric motors. The multiple electric motors can be all be the same model or the same type of electric motor. For example, the exosuit 100 can have two servomotors. Alternatively, the multiple electric motors can include electric motors of differing models and/or types. For example, the exosuit 100 can have a DC motor and a servomotor.

The motor control signals provided by the motor controller 1010 to the motor 112 can be one or more types of signals. For example, the motor control signal provided by the motor controller 1010 to the motor 112 can be a pulse width modulation (PWM) signal where the duration of the positive pulse determines the torque, force, or velocity of the motor 112. The motor control signal provided by the motor controller 1010 can be a DC signal with a set current and/or voltage. Alternatively, the motor control signal provided by the motor controller 1010 can be an AC signal. The type of signal provided by the motor controller 1010 to the motor 112 can depend on the type of motor that the motor 112 is.

In some implementations, the motor 112 can be an electric motor that receives signals from the motor controller 1010 that indicate a desired position of the motor 112. For example, the motor 112 can be a servo motor or a stepper motor. After receiving instructions specifying a position of the motor (e.g., a position of the motor 112's rotor), power can be supplied to the motor 112 until the position of the motor 112 reaches the desired position or until the motor 112 receives a different signal indicating a different desired position from the motor controller 1010. The motor control signal provided by the motor controller 1010 can be a PWM signal to control the position of the motor 112 where, for example, the duration of the positive pulse determines the position of the motor 112.

The battery 1030 can be a rechargeable battery. For example, the battery 1030 can be a lithium-ion battery, a lithium-polymer battery, a lithium-sulphur battery, a nickel-metal hydride battery, or a carbon electrode battery.

In some implementations, a power source other than a battery is used to power the components of the exosuit 100 including the motor 112. For example, the exosuit may include one or more capacitors that are used to power the exosuit 100, such as one or more supercapacitors or ultracapacitors.

The force or torque introduced by the motor 112 is transferred to the transmission 114. The transmission 114 includes a first stage having the belt drive 1110 and a second stage having the winch drive 220. The belt drive 1110 can include a first pulley or gear and a belt connected the first pulley or gear. A rotor of the motor 112 can be coupled to the first pulley or gear of the belt drive 1110 such that the first pulley rotates as the rotor of the motor 112 rotates. The winch drive 220 can include a second pulley or gear and a winch coupled to the second pulley or gear. The belt drive 1110 can be connected to the winch drive 220 through the belt. For example, the belt can connect the first pulley or gear with the second pulley or gear such that as the first pulley or gear rotates the belt causes the second pulley or gear to rotate.

The winch of the winch drive 220 can be configured to rotate as the second pulley or gear rotates and to wind and/or unwind a cord 222. As an example, the cord 222 can have a first cord segment 324a and a second cord segment 324b. When the winch is rotated in a clockwise direction, the first cord segment 324a can be unwound while the second cord segment 324b is wound. This can introduce a clockwise torque to the knee joint of the wearer 102 to, for example, assist the wearer 102 bend (e.g., flex) their knee. When the winch is rotated in a counter-clockwise direction, the first cord segment 324a can be wound while the second cord segment 324b is unwound. This can introduce a counter-clockwise torque to the knee joint of the wearer 102 to, for example, assist the wearer 102 in straightening (e.g., extending) their leg.

The cord 322 can be formed of aramid or para-aramid fibers, such as Kevlar. As another example, the cord 322 can be metal or metal alloy cord. For example, the cord can be a steel cord that includes multipole steel wires laid in a helical pattern around a steel core. Alternatively, the cord 322 can be a composite cord. Other types of cord are discussed above.

In some implementations, the winch drive 220 drives two separate cords, e.g., with the cord segments 324a-324b being separate segments. For example, when the winch of the winch drive 220 is rotated in a clockwise direction, a first cord segment 324a can be unwound from the winch while a second cord segment 324b is wound around the winch. This can introduce a clockwise torque to the knee joint of the wearer 102 to, for example, assist the wearer 102 bend their knee. When the winch is rotated in a counter-clockwise direction, the first cord can be wound onto the winch while the second cord is unwound from the winch. This can introduce a counter-clockwise torque to the knee joint of the wearer 102 to, for example, assist the wearer 102 in straightening their leg.

The winch drive 220 can be a capstan drive. For example, the winch drive 220 can be a capstan drive that includes a spool 320 (e.g., a drum or pulley) that may or may not include cord grooves. The capstan drive can use two cords that are, for example, wrapped in a figure-eight shape around the spool 320. When the spool 320 is rotated, one of the two cords will be wound around the spool 320 and the other cord will be unwound from the spool 320. The capstan drive can provide a number of benefits such as low inertia, zero backlash, and high stiffness when compared to other gearing configurations.

As described in more detail above, the drive assembly can be configured to have a high speed ratio (e.g., reduction ratio or gear ratio). The high speed ratio can be achieved in part by, for example, using a drive pulley or gear in the winch drive 220 that has a diameter significantly larger than the pulley or gear in the belt drive 1110. The high speed ratio can be achieved in part by, for example, using a winch in the winch drive 220 that has a diameter significantly less than the drive pulley or gear in the winch drive 220 in order to provide a speed ratio greater than one in a first stage of the transmission 114. The high speed ratio can also be achieved in part by, for example, using a spool (e.g., driven by the drive pulley or gear) that has a diameter significantly less than a diameter of the pulley 340 (e.g., the end of the distal portion 120) of the exosuit 100 in order to provide a speed ratio greater than one in a second stage of the transmission 114. The spool can be directly connected to the drive pulley or gear such that the spool and the drive pulley or gear maintain the same or substantially the same rotational speed.

In some implementations, the exosuit 100 may use other types of transmissions, or configurations other than the one shown for transmission 114.

The load cell 403 can be a load sensing device that measures force experienced at a particular location of the exosuit 100. The load cell 403 can be or include one or more strain gauges, piezo-resistive load cells, inductive load cells, reluctance load cells, and/or a magnetostrictive load cells. The load cell 403 can be configured as a bending beam load cell. However, other load cell configurations are possible. For example, the load cell 403 can be configured as a compression-tension load cell or as an S-beam load cell.

The load cell 403 can be arranged in the exosuit 100 such that it placed in or after the second stage of the transmission 114. The placement of the load cell 403 allows it to measure forces applied by the winch drive 220 and/or introduced by the wearer 102 (e.g., as the wearer 102 attempts to bend their knee or straighten their leg). As described in more detail above, a first end of the load cell can be coupled to a first guide pulley that interacts with a first cord segment of a cord driven by the winch drive 220 and a second end of the load cell can be coupled to a second guide pulley that interacts with a second cord segment of the cord driven by the winch drive 220.

As an example, the load cell 403 can be placed in line with the second stage of the transmission 114 such that the first guide pulley coupled to the load cell 403 interacts with the first cord segment at a point between the winch drive 220 and the pulley 340 of the exosuit 100 and the second guide pulley coupled to the load cell 403 interacts with the second cord segment at a different point between the winch drive 220 and the pulley 340 of the exosuit 100.

The load cell 403 can include multiple load sensing devices. For example, the load cell 403 can be a double-bending beam load cell that includes a first set of two strain gauges placed on a side of the beam load cell that faces the first guide pulley and a second set of two strain gauges placed on an opposing side of the beam load cell that faces the second guide pulley. The four strain gauges can be arranged in a Wheatstone bridge where the output of the Wheatstone bridge is the output of the load cell 403.

As an example, when the tension in the first cord segment is greater than the tension in the second cord segment, the bending beam load cell bends towards the first guide pulley which causes the first set of strain gauges to be compressed and their resistances lowered and the second set of strain gauges to be tensioned and their resistances increased. Based on the arrangement of strain gauges in the Wheatstone bridge, this can cause the output voltage of the load cell 403 to increase. When the tension in the first cord segment is less than the tension in the second cord segment, the bending beam load cell bends towards the second guide pulley which causes the first set of strain gauges to be tensioned and their resistances increased and the second set of strain gauges to be compressed and their resistances increased. If the strain gauges are arranged the same way in the Wheatstone bridge, this will cause the output voltage of the load cell 403 to decrease.

The load cell 403 can include a single sensing device. As an example, the load cell 403 can be a bending beam load cell that include a single strain gauge. In the arrangement, when the tension in the first cord segment is greater than the tension in the second cord segment, the beam load cell can bend towards the first guide pulley causing the strain gauge to compress and its resistance to lower. This can result in the output voltage of the load cell 403 increasing. When the tension in the first cord segment is less than the tension in the second cord segment, the beam load cell can bend towards the second guide pulley causing the strain gauge to tension and its resistance to increase. This can result in the output voltage of the load cell 403 decreasing.

In some implementations, the exosuit 100 includes multiple load cells. For example, the exosuit 100 can include a first load cell that is configured to measure the force applied by a first cord segment 324a of a cord driven by the winch drive 220 and a second load cell that is configured to measure the force applied by a second cord segment 324b of the cord driven by the winch drive 220.

The example exosuit 100 is shown as an exosuit for a wearer 102's right leg or knee, however various other embodiments are possible. In other embodiments, the exosuit 100 can support other joints and parts of the wearer 102's body. For example, the exosuit 100 can be an exosuit for the wearer 102's elbow, ankle, shoulders, back, and/or hips. The exosuit 100 can be an exosuit for multiple body parts of the wearer 102. For example, the exosuit 100 can be an exosuit for the wearer 102's lower body such that it includes support elements for both of the wearer 102's legs and their hips. The exosuit 100 can alternatively be a full-body exosuit that includes support elements for the wearer 102's legs, hips, back, shoulders, and arms.

In these various other embodiments, the exosuit 100 can include multiple motors to apply forces (e.g., indirectly through respective drive assemblies) to multiple joints of the wearer 102. For example, the exosuit 100 can include a motor, a corresponding drive assembly, and a corresponding load cell for each joint of the wearer 102 that the exosuit 100 is configured to support. Each of these motors can be controlled by, for example, an independent feedback loop that obtains outputs from a corresponding load cell.

FIGS. 2A-2B are block diagrams for operating the exosuit 100 using the feedback loop controller 1012. FIGS. 2A-2B show various stages (A)-(J) that correspond to different steps and/or events in the operation of the exosuit 100 in a transparent mode to maintain net-zero force. The stages A-J may occur in the illustrated sequence, or in a sequence that is different from the illustrated sequence. For example, some of the stages may occur concurrently.

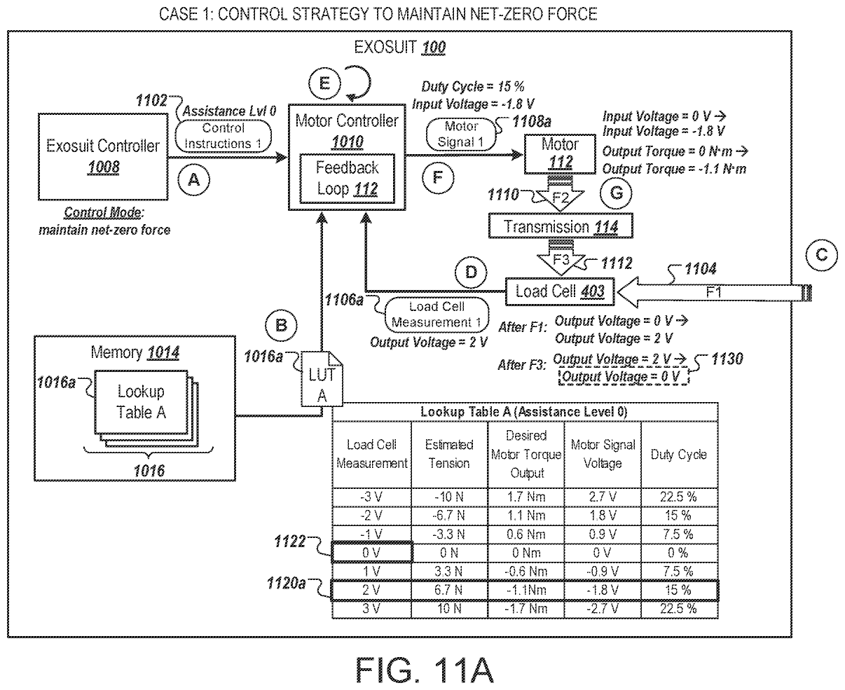

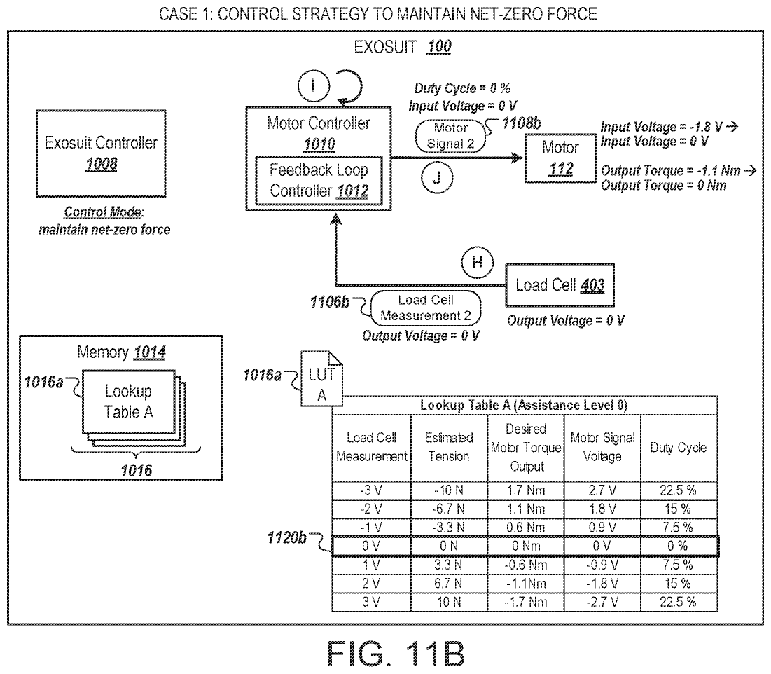

FIG. 11A shows a subset of stages (A)-(G) that depict different steps and/or events in a first cycle of operating the exosuit 100 in a transparent mode using the feedback loop controller 1012.

As will be discussed in more detail below, when the exosuit controller 1008 determines that the motor controller 1010 should be operated in a transparent mode the exosuit controller 1008 can provide instructions to the motor controller 1010 that instruct the feedback loop controller 1012 to maintain a net-zero force. In this transparent mode, the exosuit 100 can drive the motor 112 through the feedback loop controller 1012 to avoid impeding the movements of the wearer 102.

The exosuit controller 1008 can determine that the motor controller 1010 should operate in a transparent mode when certain scenarios are detected. For example, the exosuit controller 1008 can set a net-zero force when the wearer 102 is detected to be in a neutral state such that the wearer does not require powered assistance from the exosuit 100. Due to the high speed ratio between the rotation of the motor 112 and the rotation of the wearer 102's knee joint, the exosuit 100 has the potential to provide a high level of resistance (e.g., high reflected inertia or load) to the wearer 102 when the wearer 102 attempts to actuate the joint. To avoid presenting this resistance from the wearer 102, the exosuit 100 can use the load cell 403 to detect forces applied by the wearer 102 and use the feedback loop controller 1012 to actively drive the motor 112 of the exosuit to move the joint in response. The load cell 403 can provide high responsiveness and high accuracy, so the exosuit 100 can initiate movement with a relatively low force threshold. This allows the feedback loop controller 1012 to respond quickly to small movements of the wearer 102 by driving the motor 112, so as not to impede intended movements of the wearer 102.

The exosuit controller 1008 can determine that the wearer 102 of the exosuit is in a neutral state when exosuit controller 1008 determines that the wearer 102 is in a particular position or performing a particular action. For example, the exosuit controller 1008 can determine that the wearer 102 is in a neutral state, and therefore determine that control instructions to enter transparent mode should be provided to the motor controller 1010, based on a determination that the wearer 102 is sitting, lifting a leg that the exosuit 100 is fitted to, leaning, or standing.

As an example, the wearer 102 may be sitting down and may attempt to move their foot backward, perhaps to position their foot before standing up or even just allowing knee to bend freely to swing the foot back and forth. In this situation, the control unit 1006 can hide the high reflected inertia that the wearer 102 faces due to the high reduction ratio from the motor 112 to the knee joint. In other words, when the wearer 102 applies force to initiate flexion, the apparent resistance sensed by the wearer 102 is low because the feedback loop controller 1012 actively drives the motor 112 to bend the joint. For example, the wearer 102's force toward flexion increases tension in the upper cord segment and increases the force the upper cord segment applies on the load cell 403, while the same force by the wearer 102 decreases tension in the lower cord segment and decreases the force the lower cord segment applies on the load cell 403. The feedback loop controller 1012 responds by gradually driving the motor 112 to compensate for this change in net force on the load cell, by driving the motor 112 to flex the knee. The characteristics of the motor drive signals, e.g., the direction, speed, duration, and extent of motor activation, can be set based on the parameters of the feedback loop controller 1012 and the characteristics of the load cell signal over time (e.g., whether net force increases or decreases from the equilibrium point, the magnitude of change from the equilibrium point, the rate or pattern with which the load cell signal changes, how long the deviation from equilibrium persists, etc.).

In stage (A), the exosuit controller 1008 provides control instructions 1102 to the motor controller 108. The control instructions 1102 can, for example, set the level of assistance to zero so that the feedback loop controller 1012 of the motor controller 1010 maintains net-zero force (e.g., at the load cell 403 or at a different location of the exosuit 100 or of the wearer 102).

In stage (B), the motor controller 1010 accesses a data object in response to receiving the control instructions 1102 from the exosuit controller 1008. For example, in response to receiving the control instructions 1102 and based on the control instructions 1102 setting the level of assistance to zero, the motor controller 1010 can access the lookup table 1016a from the lookup tables 1016 in the memory 1014. The lookup table 1016a can be a lookup table that is used by the motor controller 1010 to generate motor control signals when the level of assistance is set to zero or when the motor controller is operating in transparent mode.

The lookup table 1016a can include information used by the feedback loop controller 1012 to generate motor control signals. For example, the lookup table 1016a can include a set of possible load cell measurements (e.g., outputs) or ranges of possible load cell measurements. The lookup table 1016a can also include a set of tensions or ranges of tensions that correspond to set of load cell measurements. For example, the tension 6.7 N can represent the force estimated at the load cell 403 when the load cell 403 outputs 2 V. The lookup table 1016a can include other information such as a set of desired motor torque outputs (e.g., to achieve a setpoint such as the possible load cell measurement 1122) that relate to the possible load cell measurements, a set of motor signal voltages to achieve the desired motor torque outputs, and a set of duty cycles for motor control signals (e.g., to achieve the motor signal voltages).

A positive load cell measurement and tension can indicate, for example, that the tension in a first cord segment that the winch drive 220 acts on is greater than the tension in a second cord segment that the winch drive 220 also acts on. A negative voltage or tension can indicate, for example, that the tension in the first cord segment is less than the tension in the second cord segment.

In some implementations, the lookup table 1016a can include other information used by the motor controller 1010 to generate motor control signals for the motor 112. For example, the lookup table 1016a can include a set of different currents such that when generating a motor control signal, the motor controller 1010 can select a particular duty cycle based on the most recent output from the load cell 403 to achieve a particular voltage at the motor 112 and a current settings to change the amount of current provided to the motor 112.

In stage (C), an external force 1104 is introduced into the exosuit 100 by the wearer 102. For example, the wearer 102 can introduce a force by starting to bend their knee. The force 1104 can act on the load cell 403. For example, the force 1104 can increase the tension in a first cord segment that is coupled to a first guide pulley coupled to the load cell 403 and decrease the tension in a second cord segment that is coupled to a second guide pulley coupled to the load cell 403.

The external force 1104 introduced by the wearer 102 can affect the force measured by the load cell 403. For example, after the force 1104 is introduced, the output voltage of the load cell 403 may change from 0 V from 2 V.

In stage (D), the motor controller 1010 obtains a load cell measurement 1106a from the load cell 403. The load cell measurement 1106a can be, for example, a voltage signal. The motor controller 1010 may obtain load cell measurements from the load cell 403 continually, such as periodically.

In stage (E), the motor controller 1010 generates a motor control signal 1108a for the motor 112 using the feedback loop controller 1012. The feedback loop controller 1012 can use the most recent load cell measurement 1106a and the lookup table 1016a to generate the motor control signal 1108a for the motor 112. For example, the feedback loop controller 1012 can use the most recent load cell measurement 1106a to identify a set of information 1120a from the lookup table 1016a based on the measurement 1106a providing that the last output of the load cell 403 was 2 V. From the set of information 1120a, the feedback loop controller 1012 can select parameter values for the motor control signal 1108a such as a motor signal voltage of −1.8 V and/or a duty cycle of 15%.

The motor control signal 1108a is expected to change or maintain operation of the motor 112 to achieve a setpoint. When the level of assistance is set to zero so that the exosuit 100 maintains a net-zero force (e.g., at the load cell 403 or at a center of rotation of a joint of the wearer 102), the setpoint may be, for example, the desired load cell measurement 1122 of 0 V or an estimated tension of 0 N experienced by the load cell 403. As an example, each of the parameter values for the motor 112 in the lookup table 1016a are expected to change or maintain operation of the motor 112 to achieve the desired load cell measurement 1122 of 0 V as an output of the load cell 403.

When the level of assistance is set to zero so that the exosuit 100 maintains a net-zero force, achieving the setpoint means that the wearer 102 substantially does not feel any assistance from the exosuit 100 or any resistance from the exosuit 100. For example, if the motor controller 1010 generated a motor control signal that did not account for the external force 1104 such as a signal that instructs the motor 112 not to be driven (e.g., PWM signal of 0% duty cycle), the wearer 102 may feel significant mechanical resistance caused by the transmission 114 (e.g., transmission having a high speed ratio) and the motor 112 as they attempt to bend their knee. However, by generating the motor control signal 1108a that does account for the external force 1104, the wearer 102 may feel substantially no mechanical resistance as they attempt to bend their knee.

As described above, in addition to a lookup table or in place of a lookup table, the feedback loop controller 1012 can use a control algorithm to generate motor control signals for the motor 112. The control algorithm can be, for example, a PID controller, a PD controller, or a PI controller.

In stage (F), the motor controller 1010 provides the motor control signal 1108a to the motor 112. The motor control signal 1108a can be a PWM signal. For example, the feedback loop controller 1012 of the motor controller 1010 can generate a PWM signal using the motor parameters of an input voltage of −1.8 V and a duty cycle of 15% determined from the lookup table 1016a. In providing this signal to the motor 112, the motor controller 1010 can invert the polarity of the applied voltage to the motor 112 to achieve the negative voltage (e.g., to get the motor to spin or apply torque in a counter-clockwise direction) and provide the PWM signal that has a duty cycle of 15% to achieve the 1.8 V (e.g., where the motor is a 9 V motor).

In response to receiving the motor control signal 1108a, the input voltage of the motor 112 can change. For example, in response to receiving the motor control signal 1108a, the input voltage at the motor 112 can change from 0 V to −1.8 V.

In response to receiving the motor signal 1108a, the output of the motor 112 can change. For example, in response to receiving the motor control signal 1108a, the output torque of the motor 112 can change from 0 N·m to −1.1 N·m. Additionally or alternatively, other operations of the motor 112 can change in response to receiving the motor control signal 1108a. For example, the speed of rotation of a rotor of the motor 112 can change. This speed change can be in addition to or instead of the change to the output torque of the motor 112.

The output of the feedback loop controller 1012 can be the motor control signal 1108a. Alternatively, the motor controller 1010 can generate the motor control signal 1108a from the most recent output of the feedback loop controller 1012.

As described above with respect to FIG. 10, the feedback loop controller 1012 can operate by continually generating motor control signals that approach or meet a setpoint for the current level of assistance. As indicated in the lookup table 1016a, when the setpoint is reached, the motor controller 1010 may generate a signal to turn off the motor 112 by, for example, setting the voltage to 0V. Alternatively, as will be described with respect to FIGS. 3A-3B, when the setpoint is reached, the motor controller 1010 can avoid generating a signal so that the motor 112 continues to operate in accordance with the last motor control signal received or the motor controller 1010 can generate a new motor control signal that is the same as the immediately preceding motor control signal.

In stage (G), the motor 112 begins operating in accordance with the motor control signal 1108a. In this operation, the motor 112 applies a force 1110 to the transmission 114 (e.g., to the first stage of the transmission 114) and, as a result, the transmission 114 (e.g., the second stage of the transmission 114) applies a force 1112 to the load cell 403.

The output of the load cell 403 can change as a result of the force 1112. For example, in response to the force 1112 being applied to the load cell 403, the output voltage of the load cell 403 can change from 2 V to an output voltage 1130 of 0 V that matches the desired load cell measurement 1122 of 0 V. In more detail, if the force 1104 increased tension in a first cord segment coupled to the second stage of the transmission 114 and decreased tension in a second cord segment coupled to the second stage of the transmission 114, the transmission 114 can introduce the force 1112 by unwinding at least a portion of first cord segment and winding at least a portion of the second cord segment. The result of the transmission 114 introducing the force 1112 would be a reduced net force being measured at the load cell 403 and, therefore, a reduced output voltage of the load cell 403.

FIG. 11B shows a subset of stages H-J that depict different steps and/or events in a second cycle of operating the exosuit 100 in a transparent mode using the feedback loop controller 1012. In more detail, FIG. 11B depicts an example cycle of operating the motor 112 using the feedback loop controller 1012 when a setpoint for the feedback loop controller 1012 is reached.

In stage (H), the motor controller 1010 obtains a second load cell measurement 1106b from the load cell 403. As shown the load cell measurement 1106b can be the output voltage 1130 of 0 V that matches the setpoint for the feedback loop controller 1012, e.g., the desired load cell measurement 1122.

In stage (I), the motor controller 1010 generates a second motor control signal 1108b for the motor 112 using the feedback loop controller 1012. The feedback loop controller 1012 can use the most recent load cell measurement 1106b and the lookup table 1016a to generate the motor control signal 1108a for the motor 112. For example, the feedback loop controller 1012 can use the most recent load cell measurement 1106b to identify a set of information 1120b from the lookup table 1016a based on the measurement 1106b providing that the last output of the load cell 403 was 0 V. From the set of information 1120b, the feedback loop controller 1012 can select parameter values for the motor control signal 1108b such as a motor signal voltage of 0 V and/or a duty cycle of 0%, indicating that the setpoint has been reached and that the motor 112 should not be driven.

In stage (J), the motor controller 1010 provides the second motor control signal 1108b to the motor 112. The motor control signal 1108b can be a PWM signal. For example, the feedback loop controller 1012 of the motor controller 1010 can generate a PWM signal using the motor parameters of an input voltage of 0 V and a duty cycle of 0% determined from the lookup table 1016a to stop the motor 112 from being driven (e.g., turn off the motor 112).

In response to receiving the motor control signal 1108b, the input voltage of the motor 112 can change. For example, in response to receiving the motor control signal 1108b, the input voltage at the motor 112 can change from −1.8 V to 0 V.

In response to receiving the motor signal 1108b, the output of the motor 112 can change. For example, in response to receiving the motor control signal 1108b, the output torque of the motor 112 can change from 0 N·m to −1.1 N·m. Additionally or alternatively, other operations of the motor 112 can change in response to receiving the motor control signal 1108b. For example, the speed of rotation of a rotor of the motor 112 can change so that the rotor stops spinning. This speed change can be in addition to or instead of the change to the output torque of the motor 112.

FIGS. 3A-3B are block diagrams for operating the exosuit 100 using the feedback loop controller 1012. FIGS. 3A-3B show various stages (A)-(J) that correspond to different steps and/or events in the operation of the exosuit 100 in an assistance mode to maintain a set level of force. The stages (A)-(J) may occur in the illustrated sequence, or in a sequence that is different from the illustrated sequence. For example, some of the stages may occur concurrently.

As described above, the exosuit controller 1008 can make high-level or intelligent determinations for controlling the exosuit 100, such as identifying a particular scenario indicative of an action that the wearer 102 has started to perform or is attempting to perform. For example, different scenarios that the exosuit controller 1008 can detect can include standing from a sitting position, walking, climbing stairs, jumping, jogging, running, sitting, leaning, laying down, standing, or the like. The exosuit controller can refer to, for example, a data object, control program, or control protocol for each of the scenarios that specifies a target force or level of assistance that the exosuit controller 1008 can set for the feedback loop controller 1012. The data object, control program, or control protocol can also specify a duration that a target force or a level of assistance should be set for before the exosuit controller 1008 provides new target force(s) for the feedback loop controller 1012 or sets a new level of assistance for the feedback loop controller 1012. Determining the scenarios can be computationally complex and, therefore, may require more computation time. However, by having the exosuit controller 1008 separate from the motor controller 1010, the feedback loop controller 1012 of the motor controller 1010 can continue to quickly generate new motor control signals based on the last set target force or level of assistance and the output of the sensing device.

The exosuit controller 1008 can continually change the target force or level of assistance for the feedback loop controller 1012 based on detected scenarios and corresponding data objects, control programs, or control protocols. For example, when the exosuit controller 1008 detects a first scenario of a wearer attempting to stand from a sitting position, the exosuit controller can change the target force for the feedback loop from net-zero force to 40 lbs in accordance with a standing program or protocol. After one second and multiple feedback loop cycles have passed, the exosuit controller can change the target force for the feedback loop from 40 lbs to 20 lbs in accordance with the standing program. When the exosuit controller detects a new scenario of the wearer reaching a standing position, the exosuit controller can, for example, change the target force from 20 lbs back to a net-zero force.

As an example, when providing assistance to the wearer 102 when the exosuit controller 1008 detects that the wearer 102 is attempting to climb stairs, the exosuit controller 1008 can provide multiple control instructions to the motor controller 1010 to change the level of assistance based on where the wearer 102 is in the motion of the climbing the stairs, based on which leg the wearer 102 is currently stepping with, based on which leg(s) of the wearer 102 are in contact with the ground, etc. The exosuit controller 1008 may provide multiple instructions within a short period of time to provide adequate powered assistance, such as multiple instructions within a second so to change the set target force or level of assistance of the feedback loop controller 1012 multiple times within a second.

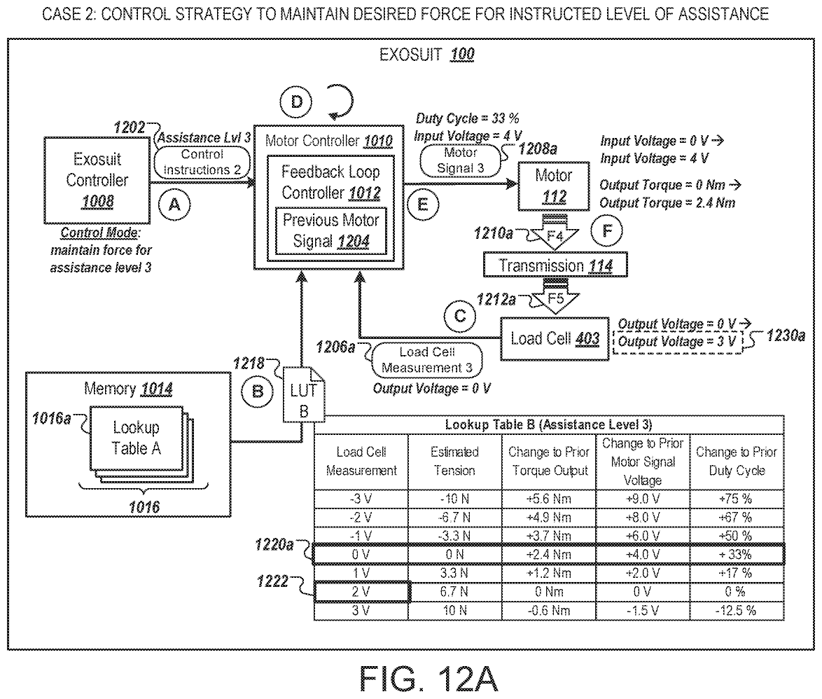

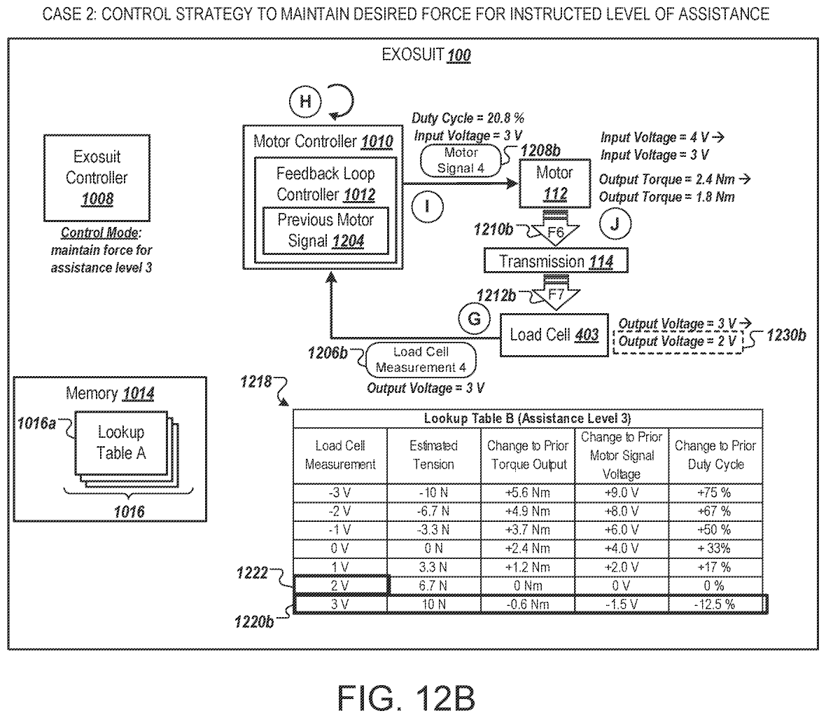

FIG. 12A shows a subset of stages A-F that depict different steps and/or events in a first cycle of operating the exosuit 100 in an assistive mode using the feedback loop controller 1012. The sequence depicted in FIG. 12A may follow the sequence depicted in FIGS. 11A-11B. For example, stage (A) of FIG. 12A may immediately follow stage (J) of FIG. 11B.

In stage (A), the exosuit controller 1008 provides control instructions 1202 to the motor controller 108. The control instructions 1202 can, for example, set the level of assistance that indicates a level of force for the feedback loop controller 1012 to maintain (e.g., through generating control instructions for the motor 112). For example, the control instructions 1202 can set the level of assistance to three that corresponds to a tension of 6.7 N so that the feedback loop controller 1012 of the motor controller 1010 maintains a force of 6.7 N (e.g., at the load cell 403 or at a different location of the exosuit 100 or of the wearer 102).

In stage (B), the motor controller 1010 accesses a data object in response to receiving the control instructions 1202 from the exosuit controller 1008. For example, in response to receiving the control instructions 1202 and based on the control instructions 1202 setting the level of assistance to three, the motor controller 1010 can access the lookup table 1218 (“Lookup Table B”) from the lookup tables 1016 in the memory 1014. The lookup table 1218 can be a lookup table that is obtained and used by the motor controller 1010 to generate motor control signals when the level of assistance is set to a particular level of assistance, such as when the level of assistance is set to three. Additionally or alternatively, the lookup table 1218 can be lookup table that is obtained and used by the motor controller 1010 to generate motor control signals when the motor controller 1010 is operating in an assistive mode (e.g., when the level of assistance is set to a non-net-zero value).

The lookup table 1218 can include information used by the feedback loop controller 1012 to generate motor control signals. For example, the lookup table 1218 can include a set of possible load cell measurements (e.g., outputs) or ranges of possible load cell measurements. The lookup table 1218 can also include a set of tensions or ranges of tensions that correspond to set of load cell measurements. For example, the tension 6.7 N can represent the force estimated at the load cell 403 when the load cell 403 outputs 2 V. The lookup table 1218 can include other information such as a set of changes to motor torque outputs (e.g., to achieve a setpoint such as the possible load cell measurement 1222) that relate to the possible load cell measurements, a set of changes to motor signal voltages to achieve the desired motor torque outputs, and a set of changes to duty cycles for motor control signals (e.g., to achieve the motor signal voltages). As will be discussed in more detail below, the feedback loop controller 1012 of the motor controller 1010 can apply these changes to a previous motor control signal, such as the immediately preceding motor control signal, to generate new motor control signals for the motor 112.

In stage (C), the motor controller 1010 obtains a load cell measurement 1206a from the load cell 403. The load cell measurement 1206a can be, for example, a voltage signal. The motor controller 1010 may obtain load cell measurements from the load cell 403 continually, such as periodically. For example, with respect to FIGS. 2A-2B, the load cell measurement 1206a may be obtained 0.01 seconds after the load cell measurement 1106b was obtained, and the load cell measurement 1106b may have been obtained 0.01 seconds after the load cell measurement 1106a was obtained. As shown, the load cell measurement 1206a may indicate that the current output voltage of the load cell 403 is 0 V.

In stage (D), the motor controller 1010 generates a motor control signal 1208a for the motor 112 using the feedback loop controller 1012. The feedback loop controller 1012 can use the most recent load cell measurement 1206a and the lookup table 1218 to generate the motor control signal 1208a for the motor 112. The feedback loop controller 1012 can also use a previous motor signal 1204 to generate the motor control signal 1208a. For example, the lookup table 1218 may specify changes to apply to the previous motor signal 1204 to generate a new motor control signal for the motor 112.

The previous motor signal 1204 can include for example a set of one or more parameters of the motor control signal last generated by the motor controller 1010. These parameters can include, for example, a duty cycle of the last signal, a voltage of the last signal, and/or a current of the last signal.

As an example, the feedback loop controller 1012 can use the most recent load cell measurement 1206a to identify a set of information 1220a from the lookup table 1218 based on the measurement 1206a providing that the last output of the load cell 403 was 0 V. From the set of information 1220a, the feedback loop controller 1012 can select changes to parameter values to apply to the previous motor signal 1204 to generate the motor control signal 1208a. For example, if the previous motor signal 1204 was the motor control signal 1108b or included the parameters of the motor control signal 1108b shown in FIG. 11B, the motor controller 1010 can generate the motor control signal 1208a by increasing the duty cycle of the motor control signal 1108b by 33% and the voltage of the motor control signal 1108b by 4.0V.

In some implementations, the previous motor signal 1204 only includes a set of one or more parameters of a previous motor control signal. For example, if the previous motor control signal was PWM signal with a duty cycle of 15% and a voltage of −1.8V, then the previous motor signal 1204 may be a data object containing two values, a first value of 15 to represent the duty cycle of the previous signal and a second value of −1.8 to represent the voltage of the previous signal.

In some implementations, the feedback loop controller 1012 does not use any previous motor signal to generate motor control signal for the motor 112. For example, the feedback loop controller 1012 may only use the most recent output of the load cell 403 and a control algorithm or lookup table to generate motor control signals for the motor 112.

The motor control signal 1208a is expected to change or maintain operation of the motor 112 to achieve a setpoint. For example, when the level of assistance is set to a non-zero value so that the exosuit 100 maintains a set amount of force (e.g., at the load cell 403 or at a center of rotation of a joint of the wearer 102), the setpoint may be, for example, the desired load cell measurement 1222 of 2 V or an estimated tension of 6.7 N experienced by the load cell 403. The lookup table 1218 can be loaded with predetermined values that are, for example, changes to motor control signal parameter values for the motor 112 that are expected to change or maintain operation of the motor 112 to achieve the set point. For example, the lookup table 1218 can be loaded with predetermines values that represent changes to be made by the motor controller 1010 to an immediately preceding motor control signal to achieve the desired load cell measurement 1222 of 2 V as an output of the load cell 403.

When the level of assistance is set to a non-zero value so that the exosuit 100 maintains a set level of force, achieving the setpoint means that the wearer 102 is assisted by the exosuit 100. For example, when the level of assistance is set to three with a setpoint of 6.7 N at a knee joint of the wearer 102, the motor controller 1010 can operate to continually drive the motor 112 so that the wearer 102 experiences 6.7 N of assistance in bending their knee.

In stage (E), the motor controller 1010 provides the motor control signal 1208a to the motor 112. The motor control signal 1208a can be a PWM signal. For example, the feedback loop controller 1012 of the motor controller 1010 can generate a PWM signal using the motor parameters of an input voltage of 4 V and a duty cycle of 33% determined from the lookup table 1218. In providing this signal to the motor 112, the motor controller 1010 can, for example, provide a PWM signal that has a duty cycle of 33% to the motor 112 to achieve the 4 V (e.g., where the motor is a 9 V motor).

In response to receiving the motor control signal 1208a, the input voltage of the motor 112 can change. For example, in response to receiving the motor control signal 1208a, the input voltage at the motor 112 can change from 0 V to 4 V.

In response to receiving the motor signal 1208a, the output of the motor 112 can change. For example, in response to receiving the motor control signal 1208a, the output torque of the motor 112 can change from 0 N·m to 2.4 N·m. Additionally or alternatively, other operations of the motor 112 can change in response to receiving the motor control signal 1208a. For example, the speed of rotation of a rotor of the motor 112 can change. This speed change can be in addition to or instead of the change to the output torque of the motor 112.

After the motor control signal 1208a is generated or provided to the motor 112, the motor controller 1010 can update the previous motor signal 1204 using the motor signal 1208a or the parameters of the motor control signal 1208a. For example, the motor controller 1010 can update the parameters values stored to refl3ect the duty cycle of 33% and the input voltage of 4V.

In some implementations, the previous motor signal 1204 used by the feedback loop controller 1012 is the most recently generated motor control signal that is looped back to the feedback loop controller 1012. For example, the feedback loop controller 1012 can contain a first loop where the most recent load cell measurement is obtained and a second loop where the most recent motor control signal is obtained.

In stage (F), the motor 112 begins operating in accordance with the motor control signal 1208a. In this operation, the motor 112 applies a force 1210a to the transmission 114 (e.g., to the first stage of the transmission 114) and, as a result, the transmission 114 (e.g., the second stage of the transmission 114) applies a force 1212a to the load cell 403.

The output of the load cell 403 can change as a result of the force 1212a. For example, in response to the force 1212a being applied to the load cell 403, the output voltage of the load cell 403 can change from 0 V to an output voltage 1230a of 3 V. In this example, the output voltage 1230a does not match the desired load cell measurement 1122 of 2 V, however it is closer to the desired load cell measurement 1222 of 2V than the previous output of the load cell 403 (e.g., output voltage of 0 V).

FIG. 12B shows a subset of stages (G)-(J) that depict different steps and/or events in a second cycle of operating the exosuit 100 in an assistance mode using the feedback loop controller 1012.

In stage G, the motor controller 1010 obtains an additional load cell measurement 1206b from the load cell 403. As shown the load cell measurement 1206b can be the output voltage 1230a of 0 V shown in FIG. 12A that corresponds to a set of information 1220b in the lookup table 1218.

In stage (H), the motor controller 1010 generates a second motor control signal 1208b for the motor 112 using the feedback loop controller 1012. The feedback loop controller 1012 can use the most recent load cell measurement 1206b, the lookup table 1016a, and the updated previous motor signal 1204 to generate the motor control signal 1208a for the motor 112. The previous motor signal 1204 may have been updated to include the motor control signal 1208a or to include motor control parameters included in the motor control signal 1208a.

As an example, the feedback loop controller 1012 can use the most recent load cell measurement 1206b to identify the set of information 1220b from the lookup table 1016a based on the measurement 1206b providing that the last output of the load cell 403 was 2 V. From the set of information 1220b, the feedback loop controller 1012 can select changes to parameter values to apply to the previous motor signal 1204 to generate the motor control signal 1208b. For example, the set of information can provide that input voltage of the motor control signal 1208a should be reduced by 1.5 V and that the duty cycle of the motor control signal 1208a should be reduced by 12.5% to generate the motor control signal 1208b.

In stage (I), the motor controller 1010 provides the additional motor control signal 1208b to the motor 112. The motor control signal 1208b can be a PWM signal. For example, the feedback loop controller 1012 of the motor controller 1010 can generate a PWM signal using the motor parameters of an input voltage of 3 V and a duty cycle of 20.8% previously determined using the lookup table 1218.

In response to receiving the motor control signal 1208b, the input voltage of the motor 112 can change. For example, in response to receiving the motor control signal 1208b, the input voltage at the motor 112 can change from 4 V to 3 V.

In response to receiving the motor signal 1208b, the output of the motor 112 can change. For example, in response to receiving the motor control signal 1208b, the output torque of the motor 112 can change from 2.4 N·m to 1.8 N·m.

In stage (J), the motor 112 begins operating in accordance with the motor control signal 1208b. In this operation, the motor 112 applies a force 1210b to the transmission 114 (e.g., to the first stage of the transmission 114) and, as a result, the transmission 114 (e.g., the second stage of the transmission 114) applies a force 1212b to the load cell 403.

The output of the load cell 403 can change as a result of the force 1212b. For example, in response to the force 1212b being applied to the load cell 403, the output voltage of the load cell 403 can change from 3 V to an output voltage 1230b of 2 V that matches the desired load cell measurement of 2 V.

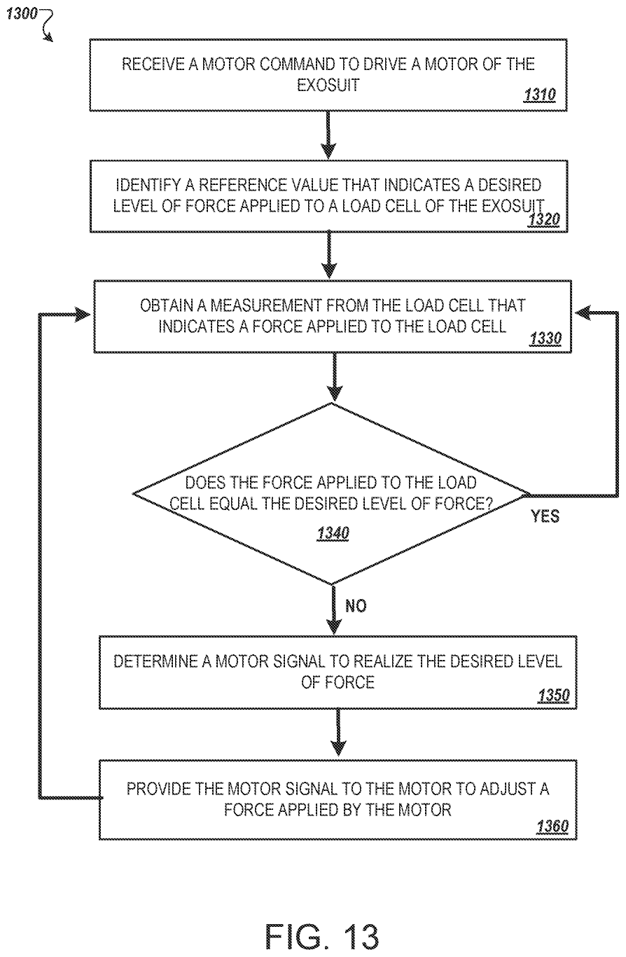

FIG. 13 is a flowchart of an example process 1300 for operating an exosuit using a feedback loop. The process 1300 can be performed by an exosuit, such as the exosuit 100 described above. For example, the process 1300 can be performed by the motor controller 1010 of the exosuit 100.

The process 400 includes receiving a motor command to drive a motor of the exosuit (410). For example, with respect to FIG. 10, the exosuit controller 1008 can provide a motor command to the motor controller 1010 that sets a level of assistance for the motor controller 1010 to maintain. This motor command can, for example, specify one or more of the level of assistance, a setpoint (e.g., reference value) to achieve, such as a desired load cell measurement from the load cell 403, a control algorithm for the feedback loop controller 1012 to use to generate motor control signals, or a lookup table for the feedback loop controller 1012 to use to generate motor control signals.

The process 400 includes identifying a reference value that indicates a desired level of force applied to a load cell of the exosuit (420). The reference value can be, for example, a level of force or a value, such as a sensor output value, that indicates a level of force. For example, the reference value can be an output of the load cell 403 that indicates (e.g., can be converted to or used to calculate) a force experienced by the load cell 403. In more detail, with respect to FIG. 10 and FIGS. 11A-11B, the motor controller 1010 can extract a desired load cell measurement of 0 V that serves as a setpoint for the feedback loop controller 1012 and indicates that the motor controller 1010 is to maintain net-zero force at the load cell 403.

The level of force can be an exact force value for a particular location of the exosuit or of a wearer of the exosuit. For example, a first level of force can be a particular, desired torque to be applied by the exosuit 100 at a center of rotation of the wearer 102's right knee.

Alternatively, the level of force can be a range of values representing a range of forces for a particular location of the exosuit or of a wearer of the exosuit. For example, a level of force of one can be a range of tensions between 2.5 N and 3 N experienced by the load cell 403.

The process 400 includes obtaining a measurement from the load cell that indicates a force applied to the load cell 430. The measurement can be an output voltage of the load cell 403 obtained by the feedback loop controller 1012 of the motor controller 1010. The output voltage of the load cell 403 can indicate an amount of force applied to the load cell 403. The amount of force can represent a combination of multiple forces, such as forces exerted on the load cell 403 by the wearer 102 and forces exerted on the load cell 403 by the transmission 114 (e.g., due, at least in part, to forces introduced by the motor 112 being driven or mechanical resistance of the motor 112 when not driven).

The process 400 includes determining whether the force applied to the load cell equals the desired level of force (440). Determining whether the force applied to the load cell equals the desired level of force can include comparing the output to the load cell that indicates the force applied to the load cell to the reference value that indicates the level of force. For example, with respect to FIG. 10, the feedback loop controller 1012 can determine whether the force applied to the load cell equals the desired level of force by generating an error by taking the difference between an output voltage of the load cell 403 and a reference value that represents a desired output voltage of the load cell 403 when the desired level of force is reached. If the error is zero, then the force applied to the load cell is equal to the desired level of force.

Alternatively, determining whether the force applied to the load cell equals the desired level of force can include determining a force applied to the load cell (e.g., by converting the output voltage of the load cell to a force) and comparing the determined force to the desired level of force. For example, with respect to FIG. 12A, the motor controller 1010 can determine that the output voltage of the load cell 403 of 0 V indicates an estimated force of 0 N is applied to the load cell 403. If the desired level of force is 6.7 N, the motor controller 1010 can determine that force applied to the load cell 403 does not equal the desired level of force.

In some implementations, determining whether the force applied to the load cell equals the desired level of force includes determining whether the force applied to the load cell is substantially equal to the desired level of force. For example, if the difference between the force applied to the load cell and the desired level of force is less than threshold percent (e.g., 0.5%, 1%, 2%, etc.) then the motor controller 1010 can determine that the desired level of force has been reached and proceed generate control instructions for the motor 112 in accordance with the desired level of force being met.

As another example, an error calculated by the feedback loop controller 1012 to generate motor control signals using a control algorithm, such as a PID controller, can be rounded to a set number of decimal places. In more detail, the error may be set to be rounded to the nearest one-tenth such that if the load cell measurement is 1.12 V and a reference value is 1.08 V, the motor controller 1010 can round the error to 0.0.

The process 400 includes determining a motor signal to realize the desired level of force if the force applied to the load cell does not equal the desired level of force (450). For example, the feedback loop controller 1012 can use a PID controller to generate a motor control signal for the motor 112 based on an error calculated by taking the difference between the force applied to the load cell and the desired level of force. Additionally or alternatively, the feedback loop controller 1012 can use values obtained from one or more lookup tables to generate motor control signals for the motor 112. For example, with respect to FIG. 11A, the feedback loop controller 1012 can use a duty cycle value specified in the lookup table 1016a to generate a PWM signal for the motor 112.

The process 400 includes providing the motor signal to the motor to adjust a force applied by the motor (460). For example, the motor controller 1010 can provide the motor signal as a PWM signal to the motor 112 to change the output torque of the motor 112. In more detail, with respect to FIG. 12B, in response to receiving the motor control signal 1208b, the output torque of the motor 112 is lowered from 2.4 N·m to 1.8 N·m.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the invention have been described. Other embodiments are within the scope of the following claims. For example, the steps recited in the claims can be performed in a different order and still achieve desirable results.

What is claimed is:

1. A method for controlling an exosuit, the method comprising:
receiving, by a controller of the exosuit, a motor command to drive a motor of the exosuit, wherein the motor is coupled to rotate a drive pulley, and wherein the drive pulley is coupled to a moveable portion of the exosuit with a cord and is configured such that rotation of the drive pulley winds or unwinds the cord around a spool coupled to the drive pulley;
determining, based on the motor command, a reference value that indicates a desired level of force;
obtaining a measurement from a load cell of the exosuit, wherein the load cell is arranged such that tension in the cord applies force to the load cell and the measurement from the load cell is based on the force applied;
based on the reference value and the measurement, determining a motor signal to provide to the motor that is expected to adjust the force applied to the load cell towards the desired level of force; and
providing the motor signal to the motor to adjust a force applied by the motor to the drive pulley.

2. The method of claim 1, comprising:
obtaining a second measurement from the load cell of the exosuit that indicates that the force applied to the load cell has changed;
determining a second motor signal that is expected to further adjust the force applied to the load cell; and
providing the second motor signal to the motor to adjust the force applied by the motor to the drive pulley.

3. The method of claim 1, wherein the cord has a first cord segment and a second cord segment, and
wherein rotation of the drive pulley in a first direction winds the first cord segment and unwinds the second cord segment, and rotation of the drive pulley in a second direction winds the second cord segment and unwinds the first cord segment.

4. The method of claim 3, wherein the load cell is arranged between the first cord segment and the second cord segment such that tension in the first cord segment and tension in the second cord segment apply opposing forces to the load cell, and
wherein the force applied to the load cell is a combination of the opposing forces applied to the load cell by the first cord segment and the second cord segment.

5. The method of claim 4, wherein the load cell is coupled to guide pulleys,
wherein a first guide pulley of the guide pulleys engages the first cord segment and a second guide pulley of the guide pulleys engages the second cord segment, and
wherein the opposing forces to the load cell are applied to the load cell through the guide pulleys.

6. The method of claim 4, wherein the load cell has a first end that is anchored to a housing of the exosuit and a second end that is movable within the housing of the exosuit, and
wherein the opposing forces to the load cell are applied to the second end of the load cell.

7. The method of claim 1, wherein the reference value is indicates a desired measurement of the load cell.

8. The method of claim 1, wherein the reference value represents a desired force applied to the load cell.

9. The method of claim 1, the method comprising accessing a lookup table that corresponds to the reference value,
wherein using the reference value and the measurement to determine the motor signal comprises identifying, from the lookup table, a motor signal for the measurement.

10. The method of claim 9, wherein the lookup table relates possible measurements from the load cell or measurement ranges to different motor signals to provide to the motor.

11. The method of claim 1, the method comprising identifying a control algorithm that corresponds to the reference value,
wherein using the reference value and the measurement to determine the motor signal comprises using the control algorithm to calculate the motor signal, wherein the measurement is provided as an input to the control algorithm.

12. The method of claim 1, wherein the load cell includes multiple sensing devices.

13. The method of claim 1, wherein the load cell includes one or more strain gauges.

14. One or more non-transitory machine-readable media storing instructions that, when executed by one or more processors of an exosuit, cause the one or more processors to perform operations comprising:
receiving a motor command to drive a motor of the exosuit, wherein the motor is coupled to rotate a drive pulley, and wherein the drive pulley is coupled to a moveable portion of the exosuit with a cord and is configured such that rotation of the drive pulley winds or unwinds the cord around a spool coupled to the drive pulley;
determining, based on the motor command, a reference value that indicates a desired level of force;
obtaining a measurement from a load cell of the exosuit, wherein the load cell is arranged such that tension in the cord applies force to the load cell and the measurement from the load cell is based on the force applied;
based on the reference value and the measurement, determining a motor signal to provide to the motor that is expected to adjust the force applied to the load cell towards the desired level of force; and
providing the motor signal to the motor to adjust a force applied by the motor to the drive pulley.

15. The one or more non-transitory machine-readable media of claim 14, wherein the operations comprise:
obtaining a second measurement from the load cell of the exosuit that indicates that the force applied to the load cell has changed;
determining a second motor signal that is expected to further adjust the force applied to the load cell; and
providing the second motor signal to the motor to adjust the force applied by the motor to the drive pulley.

16. The one or more non-transitory machine-readable media of claim 14, wherein the cord has a first cord segment and a second cord segment, and
wherein rotation of the drive pulley in a first direction winds the first cord segment and unwinds the second cord segment, and rotation of the drive pulley in a second direction winds the second cord segment and unwinds the first cord segment.

17. An exosuit comprising:
a motor;
a drive pulley, wherein the motor is coupled to rotate the drive pulley, and wherein the drive pulley is coupled to a moveable portion of the exosuit with a cord and is configured such that rotation of the drive pulley winds or unwinds the cord around a spool coupled to the drive pulley;
one or more processors; and
one or more non-transitory machine-readable media storing instructions that, when executed by one or more processors of an exosuit, cause the one or more processors to perform operations comprising:
receiving a motor command to drive the motor of the exosuit;
determining, based on the motor command, a reference value that indicates a desired level of force;
obtaining a measurement from a load cell of the exosuit, wherein the load cell is arranged such that tension in the cord applies force to the load cell and the measurement from the load cell is based on the force applied;
based on the reference value and the measurement, determining a motor signal to provide to the motor that is expected to adjust the force applied to the load cell towards the desired level of force; and
providing the motor signal to the motor to adjust a force applied by the motor to the drive pulley.

18. The exosuit of claim 17, wherein the operations comprise:
obtaining a second measurement from the load cell of the exosuit that indicates that the force applied to the load cell has changed;
determining a second motor signal that is expected to further adjust the force applied to the load cell; and
providing the second motor signal to the motor to adjust the force applied by the motor to the drive pulley.

19. The exosuit of claim 17, wherein the cord has a first cord segment and a second cord segment, and
wherein the exosuit is configured such that rotation of the drive pulley in a first direction winds the first cord segment and unwinds the second cord segment, and rotation of the drive pulley in a second direction winds the second cord segment and unwinds the first cord segment.

20. The exosuit of claim 17, wherein the load cell is arranged between the first cord segment and the second cord segment such that tension in the first cord segment and tension in the second cord segment apply opposing forces to the load cell, and
wherein the force applied to the load cell is a combination of the opposing forces applied to the load cell by the first cord segment and the second cord segment.
